(19) United States
(12) Patent Application Publication
(10) Pub. No.: US 2026/0225367 A1
(43) Pub. Date: Aug. 6, 2026

(54) LIQUID DISCHARGE HEAD, LIQUID DISCHARGE APPARATUS, AND METHOD OF MANUFACTURING LIQUID DISCHARGE HEAD

(71) Applicant: CANON KABUSHIKI KAISHA, Tokyo (JP)

(72) Inventors: KAZUHIKO EJIMA, Kanagawa (JP); SHIMPEI YOSHIKAWA, Kanagawa (JP); TAKEHO MIYASHITA, Kanagawa (JP); ISAMU YONEDA, Kanagawa (JP)

(21) Appl. No.: 19/456,577

(22) Filed: Jan. 22, 2026

(30) Foreign Application Priority Data
Feb. 3, 2025 (JP) 2025-015970

(51) Int. Cl. B41J 2/175; B41J 2/14; B41J 2/16; B41J 2/18; B41J 11/00

(52) U.S. Cl. CPC B41J 2/17523; B41J 2/14024; B41J 2/14145; B41J 2/1601; B41J 2/18; B41J 2002/14419; B41J 11/007; B41J 2202/11; B41J 2202/19

(57) ABSTRACT

Provided is a liquid discharge head including a discharge unit which includes a plurality of first flow paths; a supply unit which includes a plurality of second flow paths, to which the discharge unit is fixed, and which supplies liquid to the discharge unit; and a sealing member which is sandwiched by the discharge unit and the supply unit and which includes a plurality of third flow paths communicated with the first flow paths and the second flow paths. The sealing member includes a plurality of flow path arrays, each flow path array being constituted of the plurality of third flow paths arranged in a predetermined column direction. The sealing member includes a plurality of positioning holes to engage with the supply unit, the plurality of positioning holes being arranged on both sides of the flow path arrays in an intersecting direction that intersects with the column direction.

### BACKGROUND

### Field of the Technology

The present disclosure relates to a liquid discharge head, a liquid discharge apparatus including the liquid discharge head, and a manufacturing method of the liquid discharge head.

### Description of the Related Art

Liquid discharge apparatuses that discharge a liquid to a recording medium such as paper are mounted with a liquid discharge head that discharges the liquid. As the liquid discharge head, a configuration is known which includes a discharge unit that discharges a liquid and a supply unit that supplies a liquid to the discharge unit and which combines both units.

In such a liquid discharge head, a sealing member may be provided between the discharge unit and the supply unit to prevent liquid leakage. Japanese Patent Application Laid-open No. 2007-136871 discusses a configuration in which a sealing member having two flow paths formed with fan-shaped openings is provided.

The configuration described above is based on the premise that there are two flow paths connecting the supply unit to the discharge unit and may not be suitable for configurations with large opening dimensions of flow paths or those that include a large number of flow paths.

### SUMMARY

The present disclosure provides improved liquid-tightness of a liquid discharge head.

An aspect of the present disclosure provides a liquid discharge head that includes a discharge unit configured to discharge liquid, the discharge unit including a plurality of first liquid flow paths; a supply unit fixed to the discharge unit and configured to supply the liquid to the discharge unit, the supply unit including a plurality of second liquid flow paths; and a sealing member sandwiched by the discharge unit and the supply unit, the sealing member including a plurality of third flow paths in communication with the plurality of first liquid flow paths and the plurality of second liquid flow paths. The sealing member includes a plurality of flow path arrays, each flow path array including the plurality of third flow paths arranged in a predetermined column direction. The sealing member includes a plurality of positioning holes configured to engage with the supply unit. The plurality of positioning holes are arranged on both sides of the flow path arrays in a direction intersecting with the column direction.

Another aspect of the present disclosure provides a method of manufacturing a liquid discharge head, the liquid discharge head including a discharge unit including a plurality of first liquid flow paths; a supply unit fixed to the discharge unit, including a plurality of second liquid flow paths, and configured to supply liquid to the discharge unit; and a sealing member sandwiched by the discharge unit and the supply unit, the sealing member including a plurality of third flow paths in communication with the plurality of first flow paths and the plurality of second flow paths, and a plurality of flow path arrays, each flow path array including the plurality of third flow paths arranged in a column direction. The manufacturing method of a liquid discharge head includes a grasping operation including sucking a surface on which the plurality of third flow paths of the sealing member open with a suction head and grasping the sealing member; a positioning operation including positioning the sealing member grasped by the suction head relative to the supply unit, so that a contact surface of the supply unit contacts the sealing member; and a mounting operation of moving the suction head and placing the sealing member on the supply unit.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are diagrams illustrating a liquid discharge apparatus.

FIG. 2 is an exploded perspective view of a liquid discharge head.

FIGS. 3A and 3B are longitudinal sectional views of the liquid discharge head and an enlarged sectional view of a discharge module, respectively.

FIG. 4 is a schematic external view of a circulation unit.

FIG. 5 is a longitudinal sectional view showing a circulatory pathway.

FIG. 6 is a block diagram schematically showing the circulatory pathway.

FIGS. 7A to 7C are sectional views showing an example of pressure adjusting unit.

FIGS. 8A and 8B are external perspective views of a circulation pump.

FIG. 9 is a sectional view taken along line IX-IX of the circulation pump shown in FIG. 8A.

FIGS. 10A to 10E are diagrams illustrating flow of ink into the liquid discharge head.

FIGS. 11A and 11B are schematic views showing a circulatory pathway in a discharge unit.

FIG. 12 is a diagram showing an opening plate 330.

FIG. 13 is a diagram showing a discharge element substrate.

FIGS. 14A to 14C are sectional views showing flow of ink of the discharge unit.

FIGS. 15A and 15B are sectional views showing a vicinity of a discharge port.

FIGS. 16A and 16B are sectional views showing a comparative example of a vicinity of the discharge port.

FIG. 17 is a diagram showing a comparative example of a discharge element substrate.

FIGS. 18A and 18B are diagrams showing a flow path configuration of the liquid discharge head.

FIG. 19 is a diagram showing a connection state between a main body portion of the liquid discharge apparatus and the liquid discharge head.

FIG. 20 is an exploded perspective view of a liquid discharge head according to the first embodiment.

FIGS. 21A and 21B are explanatory diagrams of a discharge unit according to the first embodiment.

FIG. 22 is a plan view of a tank holder unit according to the first embodiment.

FIG. 23 is a plan view of a sealing member according to the first embodiment.

FIG. 24 is a plan view showing the tank holder unit mounted with the sealing member.

FIGS. 25A to 25H are explanatory diagrams of a mounting step of the sealing member.

FIGS. 26A and 26B are explanatory diagrams of a coupling step of the discharge unit and the tank holder unit.

FIG. 27 is a plan view of a sealing member according to a comparative embodiment.

FIG. 28 is a plan view of a sealing member according to a second embodiment.

FIG. 29 is a plan view of a sealing member according to a third embodiment.

### DESCRIPTION OF THE EMBODIMENTS

Hereinafter, suitable embodiments of the present disclosure will be described in detail with reference to the accompanying drawings. It should be noted that the embodiments described below are not intended to limit the scope of the present disclosure, and not all combinations of features described in the embodiments are necessarily essential to solutions disclosed herein. The same constituent elements are assigned same reference numerals. While a liquid discharge head adopting a thermal system in which air bubbles are generated with a thermoelectric conversion element to discharge a liquid as a discharge element that discharges a liquid will be described as an example in the following embodiments, liquid discharge heads are not limited thereto. The present disclosure can also be applied to liquid discharge heads adopting a discharge system involving discharging a liquid using a piezoelectric element or other discharge systems. The pumps, the pressure adjusting unit, and the like described below are not limited to the specific configurations described in the embodiments and the drawings. The following description first outlines a basic configuration of the present disclosure, followed by a description of features of the present disclosure.

Liquid Discharge Apparatus

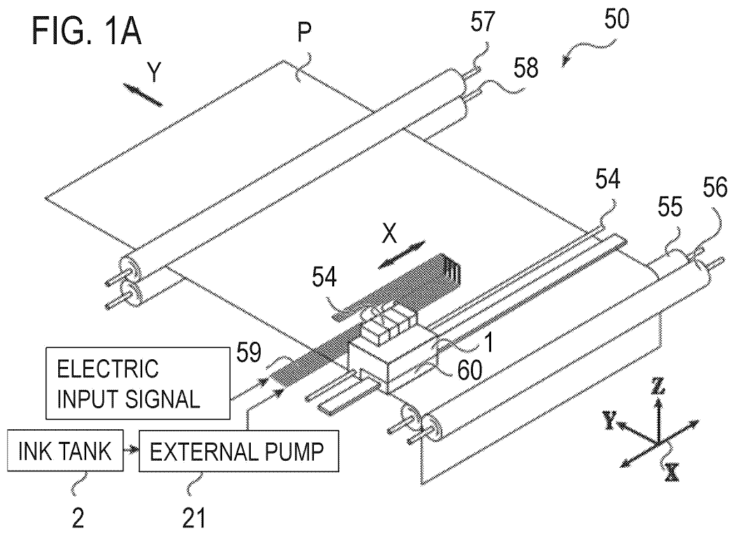

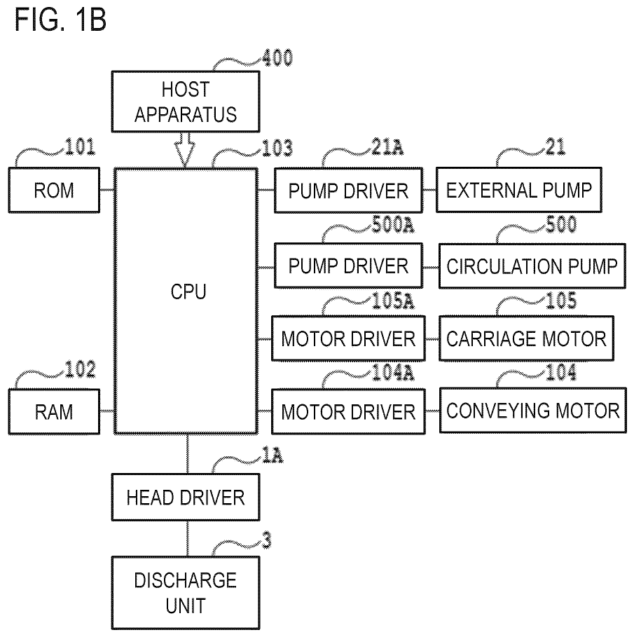

FIGS. 1A and 1B are diagrams for describing a liquid discharge apparatus and is an enlarged view of a liquid discharge head and a periphery thereof of the liquid discharge apparatus. First, a schematic configuration of a liquid discharge apparatus 50 of the present embodiment will be described with reference to FIGS. 1A and 1B. FIG. 1A is a perspective view schematically showing the liquid discharge apparatus using a liquid discharge head 1. The liquid discharge apparatus 50 according to the present embodiment constitutes a serial-type inkjet recording apparatus which performs recording on a recording medium P by discharging ink as a liquid while scanning the recording medium P with the liquid discharge head 1.

The liquid discharge head 1 is mounted on a carriage 60. The carriage 60 reciprocates along a main scanning direction (X direction) along a guide shaft 51. The recording medium P is conveyed in a sub-scanning direction (Y direction) which intersects with (in the present example, orthogonal to) the main scanning direction by conveying rollers 55, 56, 57, and 58. In each of the drawings, as referred to below, a Z direction represents a vertical direction which intersects with (in the present example, orthogonal to) an X-Y plane defined by the X direction and the Y direction. The liquid discharge head 1 is configured to be detachable from and attachable to the carriage 60 by a user.

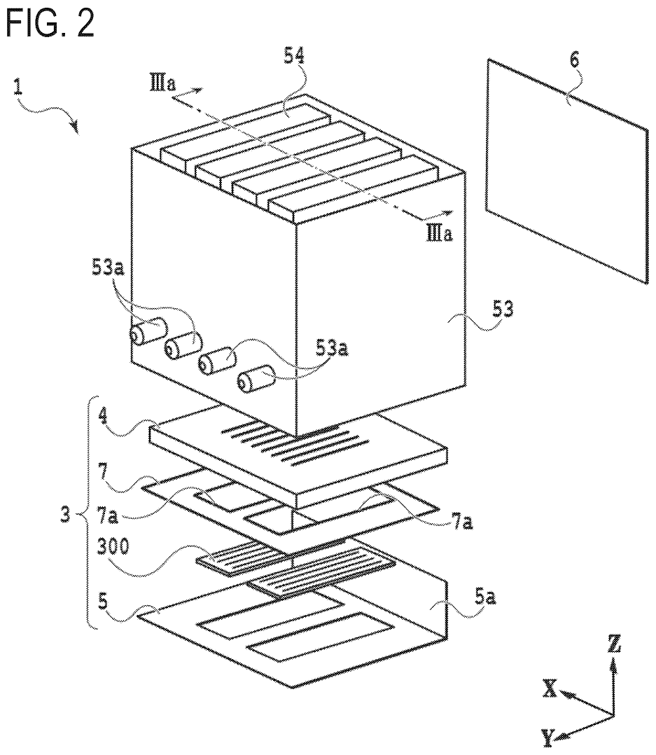

The liquid discharge head 1 is configured so as to include a circulation unit 54 and a discharge unit 3 (FIG. 2) to be described later. While a specific configuration will be described later, the discharge unit 3 is provided with a plurality of discharge ports and an energy generation element (hereinafter, referred to as discharge elements) which generate discharge energy for discharging a liquid from each discharge port.

In addition, the liquid discharge apparatus 50 is provided with an ink tank 2 which is a supply source of the ink and an external pump 21, and the ink stored in the ink tank 2 is supplied to the circulation unit 54 via an ink supply tube 59 by a driving

### Force of the External Pump 21.

The liquid discharge apparatus 50 forms a prescribed image on the recording medium P by repetitively performing a recording scan in which the liquid discharge head 1 mounted to the carriage 60 discharges ink and performs recording while moving in the main scanning direction and a conveying operation of conveying the recording medium P in the sub-scanning direction. The liquid discharge head 1 according to the present embodiment is capable of discharging four types of ink, namely, black (K), cyan (C), magenta (M), and yellow (Y), and is capable of recording full-color images using these inks. However, the inks that can be discharged from the liquid discharge head 1 are not limited to the four types of ink described above. The present disclosure is also applicable to liquid discharge heads for discharging other types of ink. In other words, there are no limits to the types and numbers of ink to be discharged from the liquid discharge head.

In addition, the liquid discharge apparatus 50 is provided with a cap member capable of covering a discharge port surface on which the discharge ports of the liquid discharge head 1 are formed at a position distanced in the X direction from a conveying path of the recording medium P. The cap member covers the discharge port surface of the liquid discharge head 1 when a recording operation is not being performed and is used to prevent drying and to protect the discharge ports, perform an ink suction operation from the discharge ports, and the like.

While the liquid discharge head 1 shown in FIG. 1A represents an example in which the liquid discharge head 1 is provided with four circulation units 54 corresponding to four types of ink, circulation units 54 corresponding to the types of liquid to be discharged need only be provided. In addition, a plurality of the circulation units 54 may be provided with respect to liquids of the same type. In other words, the liquid discharge head 1 can be configured to include one or more circulation units. A configuration may be adopted in which only at least one type of ink is circulated instead of causing all four types of ink to be circulated.

FIG. 1B is a block diagram showing a control system of the liquid discharge apparatus 50. A central processing unit (CPU) 103 functions as control unit which controls operations of each portion of the liquid discharge apparatus 50 based on a program of processing procedures or the like stored in a read only memory (ROM) 101. A random access memory (RAM) 102 is used as a work area when the CPU 103 executes processing or the like. The CPU 103 receives image data from a host apparatus 400 outside of the liquid discharge apparatus 50 and controls a head driver 1A and controls driving of a discharge element provided in the discharge unit 3. In addition, the CPU 103 also controls drivers of various actuators that are provided in the liquid discharge apparatus. For example, the CPU 103 controls a motor driver 105A of a carriage motor 105 for moving the carriage 60, a motor driver 104A of a conveying motor 104 for conveying the recording medium P, and the like. The CPU 103 controls a pump driver 500A that drives a circulation pump 500 to be described later, a pump driver 21A of the external pump 21, and the like. While FIG. 1B shows a mode of performing processing of receiving image data from the host apparatus 400, processing may be performed by the liquid discharge apparatus 50 independently of data from the host apparatus 400.

### Basic Configuration of Liquid Discharge Head

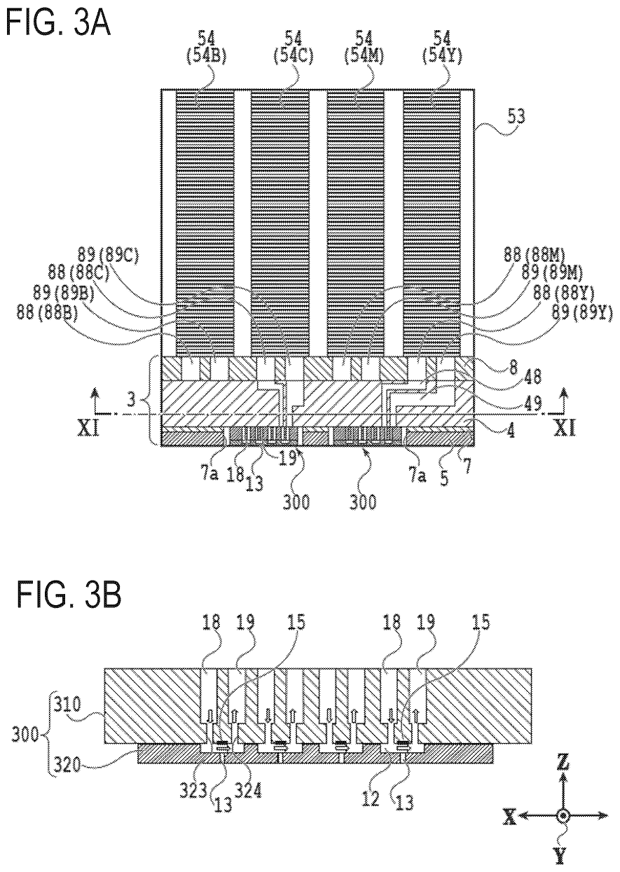

FIG. 2 is an exploded perspective view of the liquid discharge head 1 according to the present embodiment. FIGS. 3A and 3B are sectional view taken along line IIIA-IIIA of the liquid discharge head 1 shown in FIG. 2. FIG. 3A is a longitudinal sectional view of the liquid discharge head 1 as a whole, and FIG. 3B is an enlarged view of a discharge module shown in FIG. 3A. Hereinafter, a basic configuration of the liquid discharge head 1 according to the present embodiment will be described mainly on the basis of FIGS. 2, 3A, and 3B, while referring to FIGS. 1A and 1B as appropriate.

As shown in FIG. 2, the liquid discharge head 1 is configured so as to include the circulation unit 54 and the discharge unit 3 for discharging ink supplied from the circulation unit 54 to the recording medium P. The liquid discharge head 1 according to the present embodiment is fixedly supported on a carriage 60 of a liquid discharge apparatus 50 by positioning unit and electrical contacts provided on the carriage 60. The liquid discharge head 1 discharges ink while moving in a main scanning direction (X direction) shown in FIGS. 1A and 1B together with the carriage 60 and performs recording on the recording medium P.

The external pump 21 connected to an ink tank 2 to be a supply source of ink is provided with an ink supply tube 59 (FIGS. 1A and 1B). A liquid connector is provided at a leading end of the ink supply tube 59. When the liquid discharge head 1 is mounted to the liquid discharge apparatus 50, the liquid connector provided at the leading end of the ink supply tube 59 is connected in an air tight manner to a liquid connector insertion opening 53a which is a liquid feed port provided in a head housing 53 of the liquid discharge head 1. Accordingly, an ink supply path from the ink tank 2 to the liquid discharge head 1 via the external pump 21 is formed. In the present embodiment, since four types of ink are used, four sets of ink tanks 2, external pumps 21, ink supply tubes 59, and circulation units 54 are provided corresponding to each ink, and four ink supply paths corresponding to each ink are formed independently. In this manner, the liquid discharge apparatus 50 according to the present embodiment includes an ink supply system to which ink is supplied from the ink tank 2 provided outside of the liquid discharge head 1. The liquid discharge apparatus 50 according to the present embodiment does not include an ink recovery system that recovers the ink inside of the liquid discharge head 1 to the ink tank 2. Therefore, while the liquid discharge head 1 is provided with the liquid connector insertion opening 53a for connecting the ink supply tube 59 of the ink tank 2, the liquid discharge head 1 is not provided with a connector insertion opening for connecting a tube for recovering the ink inside of the liquid discharge head 1 to the ink tank 2. The liquid connector insertion opening 53a is provided for each ink.

In FIGS. 3A and 3B, reference sign 54B denotes a circulation unit for black ink, reference sign 54C denotes a circulation unit for cyan ink, reference sign 54M denotes a circulation unit for magenta ink, and reference sign 54Y denotes a circulation unit for yellow ink. Each circulation unit has a substantially similar configuration, and when each circulation unit is not specifically distinguished in the present embodiment, the circulation units will all be referred to as the circulation unit 54.

In FIGS. 2 and 3A, the discharge unit 3 includes two discharge modules 300, a first supporting member 4, a second supporting member 7, an electric wiring member (electric wiring tape) 5, and an electric contact substrate 6. As shown in FIG. 3B, the discharge module 300 includes a silicon substrate 310 with a thickness of 0.5 to 1 mm and a plurality of discharge elements 15 provided on one surface of the silicon substrate 310. The discharge elements 15 according to the present embodiment are include an electric thermal conversion element (heater) that generates heat energy as discharge energy for discharging a liquid. Each discharge element 15 is supplied with power via electric wiring formed on the silicon substrate 310 using a film deposition technique.

In addition, a discharge port forming member 320 is formed on a front surface (lower surface in FIG. 3B) of the silicon substrate 310. A plurality of pressure chambers 12 corresponding to the plurality of discharge elements 15 and a plurality of discharge ports 13 which discharge ink are formed on the discharge port forming member 320 by a photolithographic technique. A common supply flow path 18 and a common recovery flow path 19 are formed on the silicon substrate 310. In addition, a supply connection flow path 323 that communicates the common supply flow path 18 and each pressure chamber 12 with each other and a recovery connection flow path 324 that communicates the common recovery flow path 19 and each pressure chamber 12 with each other are formed on the silicon substrate 310. In the present embodiment, one discharge module 300 is configured to discharge two types of ink. In other words, of the two discharge modules shown in FIG. 3A, the discharge module 300 positioned to the left in the diagram discharges black ink and cyan ink while the discharge module 300 positioned to the right in the diagram discharges magenta ink and yellow ink. This combination is merely an example, and the inks may be combined in any way. A configuration in which one discharge module discharges one type of ink may be adopted or a configuration in which one discharge module discharged three or more types of ink may be adopted. Two discharge modules 300 need not necessarily discharge the same number of types of ink. A configuration including one discharge module 300 may be adopted or a configuration including three or more discharge modules 300 may be adopted. In the example shown in FIGS. 3A and 3B, two discharge port arrays extending in the Y direction are formed with respect to one ink color. The pressure chamber 12, the common supply flow path 18, and the common recovery flow path 19 are formed, respectively, with respect to each of the plurality of discharge ports 13 that constitute each discharge port array.

An ink supply port and an ink recovery port (to be described later) are formed on a rear surface (upper surface in FIG. 3B) of the silicon substrate 310. The ink supply port supplies ink to the plurality of common supply flow paths 18 from an ink supply flow path 48, and the ink recovery port recovers ink from the plurality of common recovery flow paths 19 to an ink recovery flow path 49.

The ink supply port and the ink recovery port referred to here denote openings through which ink is supplied and recovered during ink circulation in a forward direction to be described later. In other words, during ink circulation in the forward direction, ink is supplied from the ink supply port to each common supply flow path 18 and ink is recovered from each common recovery flow path 19 to the ink recovery port. However, ink circulation that causes ink to flow in an opposite direction may also be performed. In this case, ink is supplied from the ink recovery port to the common recovery flow paths 19 and ink is recovered from the common supply flow paths 18 to the ink supply port.

As shown in FIG. 3A, a rear surface (upper surface in FIG. 3A) of the discharge module 300 is bonded and fixed to one surface (lower surface in FIG. 3A) of the first supporting member 4. The ink supply flow path 48 and the ink recovery flow path 49 are formed in the first supporting member 4 so as to penetrate the first supporting member 4 from one surface to the other surface. One opening of the ink supply flow path 48 is communicated with the ink supply port described earlier in the silicon substrate 310, and one opening of the ink recovery flow path 49 is communicated with the ink recovery port described earlier in the silicon substrate 310. The ink supply flow path 48 and the ink recovery flow path 49 are provided independently for each type of ink.

In addition, the second supporting member 7 that has an opening 7a (FIG. 2) into which the discharge module 300 is to be inserted is bonded and fixed to one surface (upper surface in FIG. 3A) of the first supporting member 4. The second supporting member 7 holds an electric wiring member 5 that is electrically connected to the discharge module 300. The electric wiring member 5 is a member for applying an electric signal for discharging ink to the discharge module 300. An electric connection portion between the discharge module 300 and the electric wiring member 5 is sealed by a sealing material and protected from corrosion by ink or external impact.

An electric contact substrate 6 is bonded by thermal compression bonding using an anisotropic conductive film to an end portion 5a (FIG. 2) of the electric wiring member 5 and the electric wiring member 5 and the electric contact substrate 6 are electrically connected to each other. The electric contact substrate 6 includes an external signal input terminal for receiving electric signals from the liquid discharge apparatus 50.

A joint member 8 (FIG. 3A) is provided between the first supporting member 4 and the circulation unit 54. A supply port 88 and a recovery port 89 are formed for each type of ink in the joint member 8. The supply port 88 and the recovery port 89 communicate the ink supply flow path 48 and the ink recovery flow path 49 of the first supporting member 4 with the flow path formed in the circulation unit 54. In FIG. 3A, a supply port 88B and a recovery port 89B correspond to black ink and a supply port 88C and a recovery port 89C correspond to cyan ink. In addition, a supply port 88M and a recovery port 89M correspond to magenta ink and a supply port 88Y and a recovery port 89Y correspond to yellow ink.

Openings of respective one end portions of the ink supply flow path 48 and the ink recovery flow path 49 of the first supporting member 4 have a small opening area matching the ink supply port and the ink recovery port in the silicon substrate 310. In contrast, openings at the respective other end portions of the ink supply flow path 48 and the ink recovery flow path 49 of the first supporting member 4 have a shape that is enlarged to an opening area identical to a large opening area of the joint member 8 formed to match the flow path of the circulation unit 54. Adopting such a configuration enables an increase in flow path resistance with respect to ink collected from each recovery flow path to be suppressed. However, shapes of the openings of the respective one end portions and other end portions of the ink supply flow path 48 and the ink recovery flow path 49 are not limited to the example described above.

In the liquid discharge head 1 configured as described above, ink supplied to the circulation unit 54 passes through the supply port 88 of the joint member 8 and the ink supply flow path 48 of the first supporting member 4 and flows into the common supply flow path 18 from the ink supply port of the discharge module 300. Subsequently, the ink flows into the pressure chamber 12 from the common supply flow path 18 via the supply connection flow path 323, and a part of the ink flowed into the pressure chamber is discharged from the discharge port 13 due to driving of the discharge element 15. The remaining ink that had not been discharged flows from the pressure chamber 12 via the recovery connection flow path 324 and the common recovery flow path 19, and flows into the ink recovery flow path 49 of the first supporting member 4 from the ink recovery port. In addition, the ink flowed into the ink recovery flow path 49 flows into the circulation unit 54 via the recovery port 89 of the joint member 8 to be recovered.

### Constituent Elements of Circulation Unit

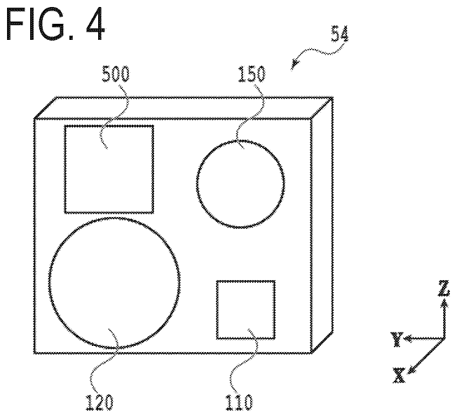

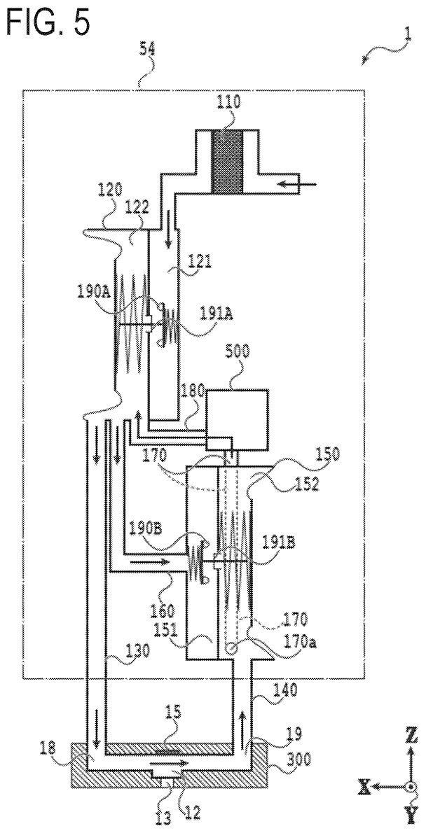

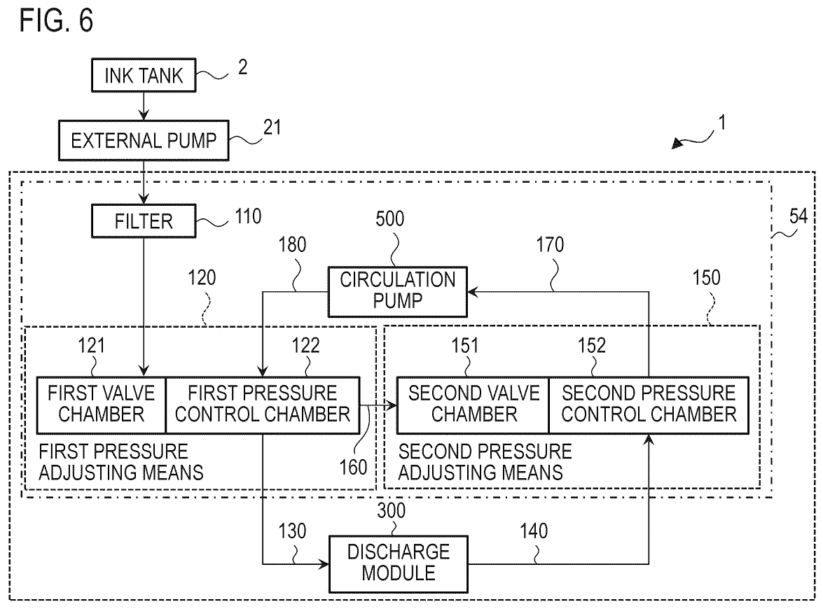

FIG. 4 is a schematic external view of one circulation unit 54 corresponding to one type of ink that is applied to a recording apparatus according to the present embodiment. A filter 110, first pressure adjusting unit 120, second pressure adjusting unit 150, and the circulation pump 500 are arranged in the circulation unit 54, elements of which are connected by each flow path as shown in FIGS. 5 and 6 and constitute a circulatory flow path which performs supply and recovery of ink with respect to the discharge modules 300 in the liquid discharge head 1.

### Circulatory Pathway in Liquid Discharge Head

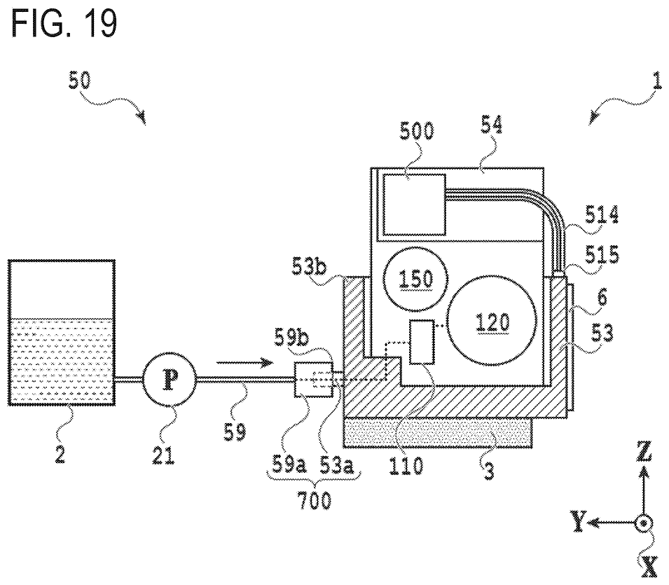

FIG. 5 is a longitudinal sectional view schematically showing a circulatory pathway for one type of ink (ink of one color) constructed in the liquid discharge head 1. For clarity, the circulatory path is described with the relative positions of the respective components (the first pressure adjusting unit 120, the second pressure adjusting unit 150, the circulation pump 500, and the like) in FIG. 5 shown in a simplified manner. Therefore, the relative positions of the respective components may differ from the configuration shown in FIG. 19, described later. FIG. 6 is a block diagram schematically showing the circulatory pathway shown in FIG. 5. As shown in FIGS. 5 and 6, the first pressure adjusting unit 120 includes a first valve chamber 121 and a first pressure control chamber 122. The second pressure adjusting unit 150 includes a second valve chamber 151 and a second pressure control chamber 152. The first pressure adjusting unit 120 is configured so that control pressure thereof is relatively higher than that of the second pressure adjusting unit 150. In the present embodiment, circulation of ink in a certain pressure range is realized in the circulatory pathway by using both the first pressure adjusting unit 120 and the second pressure adjusting unit 150. In addition, a configuration is adopted in which ink flows through the pressure chamber 12 (discharge element 15) at a flow rate in accordance with a pressure difference between the first pressure adjusting unit 120 and the second pressure adjusting unit 150. Hereinafter, the circulatory pathway in the liquid discharge head 1 and flow of ink in the circulatory pathway will be described with reference to FIGS. 5 and 6. Arrows in each drawing depict a direction in which the ink flows.

A connection state of each constituent element of in the liquid discharge head 1 is now described.

The external pump 21 which sends the ink housed in the ink tank 2 (FIG. 6) provided outside of the liquid discharge head 1 to the liquid discharge head 1 is connected to the circulation unit 54 via the ink supply tube 59 (FIGS. 1A and 1B). The filter 110 is provided in an ink flow path positioned on an upstream side of the circulation unit 54. An ink supply path positioned on a downstream side of the filter 110 is connected to the first valve chamber 121 of the first pressure adjusting unit 120. The first valve chamber 121 is communicated with the first pressure control chamber 122 via a communication port 191A that can be opened and closed by a valve 190A shown in FIG. 5.

The first pressure control chamber 122 is connected to a supply flow path 130, a bypass flow path 160, and a pump outlet flow path 180 of the circulation pump 500. The supply flow path 130 is connected to the common supply flow path 18 via the ink supply port described earlier that is provided in the discharge module 300. In addition, the bypass flow path 160 is connected to the second valve chamber 151 provided in the second pressure adjusting unit 150. The second valve chamber 151 is communicated with the second pressure control chamber 152 via a communication port 191B that can be opened and closed by a valve 190B (FIG. 5). FIGS. 5 and 6 show an example in which one end of the bypass flow path 160 is connected to the first pressure control chamber 122 of the first pressure adjusting unit 120 and another end of the bypass flow path 160 is connected to the second valve chamber 151 of the second pressure adjusting unit 150. However, the one end of the bypass flow path 160 may be connected to the supply flow path 130 and the other end of the bypass flow path 160 may be connected to the second valve chamber 151.

The second pressure control chamber 152 is connected to a recovery flow path 140. The recovery flow path 140 is connected to the common recovery flow path 19 via the ink recovery port described earlier that is provided in the discharge module 300. The second pressure control chamber 152 is connected to the circulation pump 500 via a pump inlet flow path 170. In FIG. 5, reference sign 170a denotes an inflow port of the pump inlet flow path 170.

Next, flow of ink in the liquid discharge head 1, configured as described above, will be described. As shown in FIG. 6, the ink housed in the ink tank 2 is pressurized by the external pump 21 provided in the liquid discharge apparatus 50 and supplied to the circulation unit 54 of the liquid discharge head 1 as an ink flow under positive pressure.

The ink supplied to the circulation unit 54 passes through the filter 110 to have foreign objects such as dust and air bubbles removed therefrom and subsequently flows into the first valve chamber 121 provided in the first pressure adjusting unit 120. While pressure of the ink drops due to pressure loss when the ink passes through the filter 110, the pressure of the ink at this stage is in a state of positive pressure. Subsequently, when the valve 190A is open, the ink having flowed into the first valve chamber 121 passes through the communication port 191A and flows into the first pressure control chamber 122. Due to pressure loss when passing through the communication port 191A, the ink having flowed into the first pressure control chamber 122 changes from positive pressure to negative pressure.

Next, flow of ink in the circulatory path will be described. The circulation pump 500 operates so as to send out ink sucked from the pump inlet flow path 170 on the upstream side to the pump outlet flow path 180 on the downstream side. Therefore, due to the pump being driven, the ink supplied to the first pressure control chamber 122 flows into the supply flow path 130 and the bypass flow path 160 together with the ink fed from the pump outlet flow path 180. Although details will be provided later, in the present embodiment, a piezoelectric diaphragm pump using a piezoelectric element affixed to a diaphragm as a driving source is used as a circulation pump capable of feeding liquid. The piezoelectric diaphragm pump has a pump chamber capacity that based on drive voltage input to the piezoelectric element, and the piezoelectric diaphragm pump feeds a liquid by having two check valves alternately operate due to a pressure fluctuation.

The ink flowed into the supply flow path 130 flows into the pressure chamber 12 via the common supply flow path 18 from the ink supply port of the discharge module 300 and a part of the ink is discharged from the discharge port 13 due to driving (heat generation) of the discharge element 15. In addition, the remaining ink that had not been used for the discharge flows in the pressure chamber 12, passes through the common recovery flow path 19, and subsequently flows into the recovery flow path 140 that is connected to the discharge module 300. The ink flowed into the recovery flow path 140 flows into the second pressure control chamber 152 of the second pressure adjusting unit 150.

On the other hand, the ink having flowed into the bypass flow path 160 from the first pressure control chamber 122 flows into the second valve chamber 151 and subsequently passes through the communication port 191B and flows into the second pressure control chamber 152. The ink having flowed into the second pressure control chamber 152 via the bypass flow path 160 and the ink having been recovered from the recovery flow path 140 are sucked into the circulation pump 500 via the pump inlet flow path 170 due to driving of the circulation pump 500. In addition, the ink sucked into the circulation pump 500 is sent to the pump outlet flow path 180 and once again flows into the first pressure control chamber 122. Subsequently, the ink that flows into the second pressure control chamber 152 via the supply flow path 130 and the discharge module 300 from the first pressure control chamber 122 and the ink that flows into the second pressure control chamber 152 via the bypass flow path 160 flow into the circulation pump 500. In addition, the ink is fed from the circulation pump 500 to the first pressure control chamber 122. The circulation of ink in the circulatory pathway is to be performed in this manner.

As described above, in the present embodiment, a liquid can be caused to circulate along a circulatory pathway formed in the liquid discharge head 1 using the circulation pump 500. Therefore, thickening of ink or a deposition of sedimentary components of ink such as color materials in the discharge module 300 can be suppressed and flowability of the ink in the discharge module 300 and discharge characteristics at the discharge ports can be kept in favorable states.

In addition, since the circulatory pathway in the present embodiment adopts a configuration in which the circulatory pathway is contained in the liquid discharge head 1, a circulatory pathway length can be significantly shortened as compared to a case where ink is circulated between the ink tank 2 provided outside of the liquid discharge head 1 and the liquid discharge head 1. Therefore, ink can be circulated using a small circulation pump.

The connection flow path between the liquid discharge head 1 and the ink tank 2 is constituted solely of a flow path which supplies ink. In other words, a configuration is adopted which does not require a flow path for recovering ink from the liquid discharge head 1 to the ink tank 2. As a result, a tube for supplying ink need only be provided to connect the ink tank 2 and the liquid discharge head 1 with each other and a tube for recovering ink need not be provided. Therefore, the inside of the liquid discharge apparatus 50 can be configured in a simple manner with a reduced number of tubes and the entire apparatus can be downsized. A reduction in the number of tubes enables a pressure fluctuation of ink attributable to swinging of tubes that accompany main scanning of the liquid discharge head 1 to be reduced. In addition, swinging of tubes that occurs during main scanning of the liquid discharge head 1 becomes a drive load on the carriage motor which drives the carriage 60. Therefore, by reducing the number of tubes, the drive load on the carriage motor can be reduced and a main scanning mechanism including the carriage motor can be simplified. Since there is no longer a need to recover ink from the liquid discharge head to the ink tank, the external pump 21 can also be downsized. In this manner, according to the present embodiment, downsizing and cost reduction of the liquid discharge apparatus 50 can be realized.

### Pressure Adjusting Means

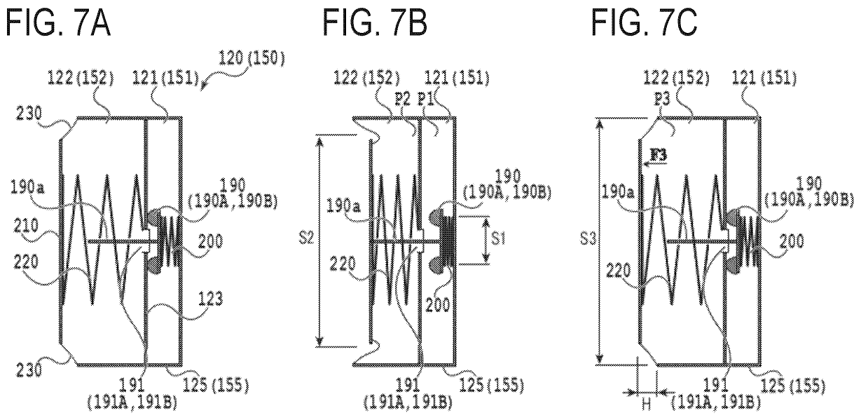

FIGS. 7A to 7C are diagrams showing an example of pressure adjusting unit. Configurations and workings of the pressure adjusting unit (the first pressure adjusting unit 120 and the second pressure adjusting unit 150) which are built into the liquid discharge head 1 described above will be described in greater detail with reference to FIGS. 7A to 7C. The first pressure adjusting unit 120 and the second pressure adjusting unit 150 are configured substantially the same. Therefore, hereinafter, the first pressure adjusting unit 120 will be described as an example and the description of the second pressure adjusting unit 150 will be limited to notating reference signs of portions corresponding to the first pressure adjusting unit in FIGS. 7A to 7C. In the case of the second pressure adjusting unit 150, the first valve chamber 121 described below shall be replaced with the second valve chamber 151 and the first pressure control chamber 122 shall be replaced with the second pressure control chamber 152.

The first pressure adjusting unit 120 includes the first valve chamber 121 and the first pressure control chamber 122 formed inside of a cylindrical housing 125. The first valve chamber 121 and the first pressure control chamber 122 are separated by a bulkhead 123 provided inside of the cylindrical housing 125. However, the first valve chamber 121 is communicated with the first pressure control chamber 122 via a communication port 191 formed in the bulkhead 123. The first valve chamber 121 is provided with a valve 190 which switches between communication and shut-off between the first valve chamber 121 and the first pressure control chamber 122 in the communication port 191. The valve 190 is held by a valve spring 200 at a position where the valve 190 opposes the communication port 191 and is configured to be capable of coming into close contact with the bulkhead 123 due to a biasing force of the valve spring 200. The distribution of ink in the communication port 191 is shut off when the valve 190 comes into close contact with the bulkhead 123. In order to increase a degree of close contact with the bulkhead 123, a portion of the valve 190 which comes into contact with the bulkhead 123 may be formed of an elastic member. In addition, a valve shaft 190a to be inserted into the communication port 191 is provided so as to protrude from a central portion of the valve 190. When the valve shaft 190a is pressed against the biasing force of the valve spring 200, the valve 190 separates from the bulkhead 123 and enables ink to be distributed through the communication port 191. Hereinafter, a state where the distribution of ink through the communication port 191 is shut off by the valve 190 will be referred to as a “closed state” and the state where the distribution of ink through the communication port 191 is enabled will be referred to as an “open state”.

An opening portion of the cylindrical housing 125 is closed by a flexible member 230 and a pressure plate 210. The first pressure control chamber 122 is formed by the flexible member 230, the pressure plate 210, a peripheral wall of the housing 125, and the bulkhead 123. The pressure plate 210 is configured so as to be displaceable accompanying a displacement of the flexible member 230. While materials of the pressure plate 210 and the flexible member 230 are not particularly limited, for example, the pressure plate 210 can be constructed of a resin molded component and the flexible member 230 may be constructed of a resin film. In this case, the pressure plate 210 can be fixed to the flexible member 230 by heat sealing.

A pressure adjustment spring 220 (biasing member) is provided between the pressure plate 210 and the bulkhead 123. Due to the biasing force of the pressure adjustment spring 220, the pressure plate 210 and the flexible member 230 are biased in a direction where an inner capacity of the first pressure control chamber 122 increases as shown in FIG. 7A. In addition, when pressure inside of the first pressure control chamber 122 decreases, the pressure plate 210 and the flexible member 230 are displaced in a direction where an inner capacity of the first pressure control chamber 122 decreases against pressure of the pressure adjustment spring 220. When the inner capacity of the first pressure control chamber 122 decreases to a certain amount, the pressure plate 210 abuts the valve shaft 190a of the valve 190. Subsequently, when the inner capacity of the first pressure control chamber 122 further decreases, the valve 190 moves together with the valve shaft 190a against the biasing force of the valve spring 200 and separates from the bulkhead 123. Accordingly, the communication port 191 changes to an open state (FIG. 7B).

In the present embodiment, connections in the circulatory path are configured so that the pressure in the first valve chamber 121 when the communication port 191 changes to the open state is higher than the pressure of the first pressure control chamber 122. Accordingly, when the communication port 191 changes to the open state, ink flows into the first pressure control chamber 122 from the first valve chamber 121. Due to the inflow of ink, the flexible member 230 and the pressure plate 210 are displaced in a direction where the inner capacity of the first pressure control chamber 122 increases. As a result, the pressure plate 210 separates from the valve shaft 190a of the valve 190, the valve 190 comes into close contact with the bulkhead 123 due to the biasing force of the valve spring 200, and the communication port 191 changes to the closed state (FIG. 7C).

In this manner, in the first pressure adjusting unit 120 according to the present embodiment, when the pressure in the first pressure control chamber 122 decreases to or below certain pressure (for example, when negative pressure increases), ink flows in from the first valve chamber 121 via the communication port 191. Accordingly, the first pressure control chamber 122 is configured so that pressure thereof does not drop any further. Therefore, the first pressure control chamber 122 is controlled so that pressure is kept within a certain range.

Next, pressure in the first pressure control chamber 122 will be described in greater detail.

A state where the flexible member 230 and the pressure plate 210 are displaced in accordance with the pressure in the first pressure control chamber 122 as described above, the pressure plate 210 abuts the valve shaft 190a, and the communication port 191 changes to the open state (FIG. 7B) will be considered. At this point, a relationship among forces acting on the pressure plate 210 is represented by Equation 1, below.

$$P 2 \times S 2 + F 2 + ( P 1 - P 2 ) \times S 1 + F 1 = 0 \qquad ( 1 )$$

Equation 1 may be organized with respect to P 2 as Equation 2, below:

$$P 2 = - ( F 1 + F 2 + P 1 \times S 1 ) / ( S 2 - S 1 ) , \qquad ( 2 )$$

with P1 being pressure (gauge pressure) in first valve chamber 121,
P2 being pressure (gauge pressure) in first pressure control chamber 122,
F1 being a spring force of valve spring 200,
F2 being a spring force of pressure adjustment spring 220,
S1 being a pressure-receiving area of valve 190, and
S2 being a pressure-receiving area of pressure plate 210.

In this case, with the spring force F1 of the valve spring 200 and the spring force F2 of the pressure adjustment spring 220, a direction in which the valve 190 and the pressure plate 210 are pressed is considered positive (rightward in FIGS. 7A to 7C). In addition, the pressure P1 of the first valve chamber 121 and the pressure P2 of the first pressure control chamber 122 are configured so that P1 satisfies a relationship expressed as P1 ≥P2.

The pressure P2 of the first pressure control chamber 122 when the communication port 191 assumes an open state is determined by Equation 2, and when the communication port 191 assumes the open state, ink flows into the first pressure control chamber 122 from the first valve chamber 121 due to adopting the relationship expressed as P1≥P2. As a result, the pressure P2 of the first pressure control chamber 122 does not drop any further and P2 is controlled to within a certain pressure range.

On the other hand, as shown in FIG. 7C, a relationship among forces that act on the pressure plate 210 when the pressure plate 210 and the valve shaft 190a change to a non-abutting state and the communication port 191 assumes a closed state is as represented by Equation 3.

$$P 3 \times S 3 + F 3 = 0 \qquad ( 3 )$$

Equation 3 may be organized with respect to P3 as Equation 4:

$$P 3 = - F 3 / S 3 \qquad ( 4 )$$

F3: spring force of pressure adjustment spring 220 when pressure plate 210 and valve shaft 190a are in non-abutting state
P3: pressure (gauge pressure) in first pressure control chamber 122 when pressure plate 210 and valve shaft 190a are in non-abutting state
S3: pressure-receiving area of pressure plate 210 when pressure plate 210 and valve 190 are in non-abutting state

In this case, FIG. 7C represents a state where the pressure plate 210 and the flexible member 230 have been displaced in a rightward direction in the drawing all the way to a displaceable limit. The pressure P3 of the first pressure control chamber 122, the spring force F3 of the pressure adjustment spring 220, and the pressure-receiving area S3 of the pressure plate 210 change according to an amount of displacement when the pressure plate 210 and the flexible member 230 are displaced to the state shown in FIG. 7C. Specifically, when the pressure plate 210 and the flexible member 230 are leftward in FIGS. 7A to 7C as compared to FIG. 7C, the pressure-receiving area S3 of the pressure plate 210 decreases and the spring force F3 of the pressure adjustment spring 220 increases. As a result, the pressure P3 of the first pressure control chamber 122 decreases according to the relationship represented by Equation 4. Therefore, according to Equation 2 and Equation 4, the pressure of the first pressure control chamber 122 gradually rises (in other words, negative pressure decreases and assumes a value approaching a positive pressure side) during a transition from the state shown in FIG. 7B to the state shown in FIG. 7C. In other words, the pressure of the first pressure control chamber gradually rises as the pressure plate 210 and the flexible member 230 are gradually displaced rightward from a state where the communication port 191 is in the open state and until the inner capacity of the first pressure control chamber 122 finally reaches a displaceable limit. In other words, negative pressure decreases.

### Circulation Pump

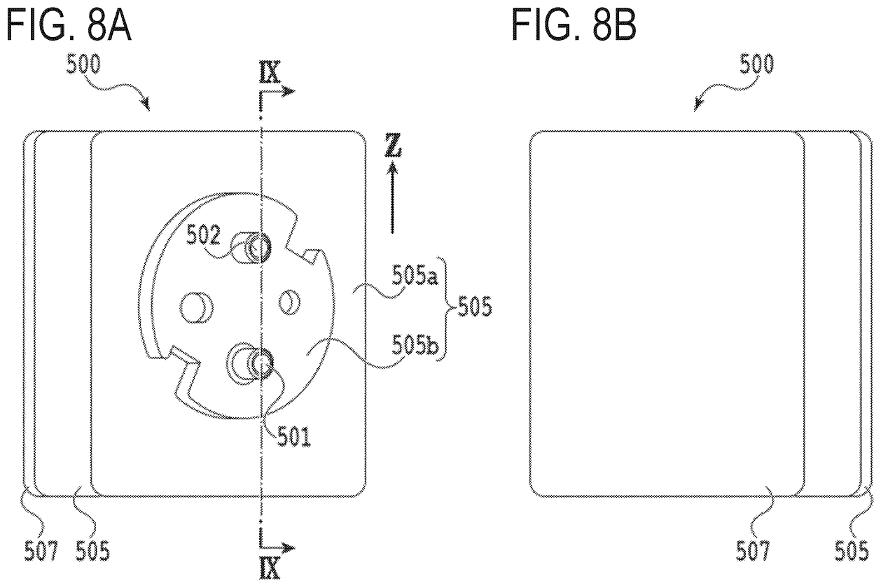

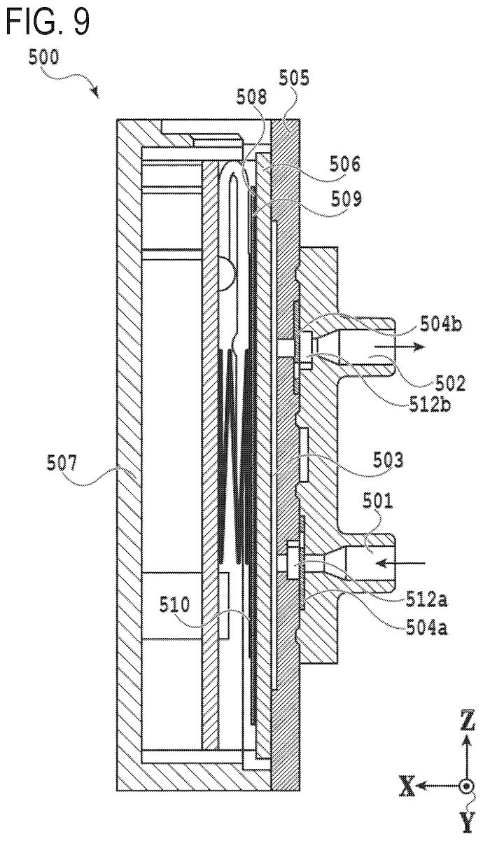

Next, configurations and workings of the circulation pump 500 which is built into the liquid discharge head 1 described above will be described in greater detail with reference to FIGS. 8A, 8B, and 9.

FIGS. 8A and 8B are external perspective views of the circulation pump 500. FIG. 8A is an external perspective view showing a front surface side of the circulation pump 500 and FIG. 8B is an external perspective view showing a rear surface side of the circulation pump 500. An outer shell of the circulation pump 500 includes a pump housing 505 and a cover 507 fixed to the pump housing 505. The pump housing 505 includes a housing portion main body 505a and a flow path connecting member 505b which is bonded and fixed to an outer surface of the housing portion main body 505a. Pairs of through-holes communicated with each other are provided at two different positions of each of the housing portion main body 505a and the flow path connecting member 505b. The pair of through-holes provided at one of the positions forms a pump supply hole 501 and the pair of through-holes provided at the other position forms a pump discharge hole 502. The pump supply hole 501 is connected to the pump inlet flow path 170 connected to the second pressure control chamber 152 and the pump discharge hole 502 is connected to the pump outlet flow path 180 connected to the first pressure control chamber 122. Ink supplied from the pump supply hole 501 passes through a pump chamber 503 (FIG. 9) to be described later and is discharged from the pump discharge hole 502.

FIG. 9 is a sectional view of the circulation pump 500 taken along line IX-IX in FIG. 8A. A diaphragm 506 is bonded to an inner surface of the pump housing 505 and the pump chamber 503 is formed in a depressed portion formed on inner surfaces of the diaphragm 506 and the pump housing 505. The pump chamber 503 is communicated with the pump supply hole 501 and the pump discharge hole 502 formed in the pump housing 505. In addition, a check valve 504a is provided in an intermediate portion of the pump supply hole 501 and a check valve 504b is provided in an intermediate portion of the pump discharge hole 502. Specifically, the check valve 504a is arranged so that a part thereof can move leftward in the drawing in a space 512a formed in the intermediate portion of the pump supply hole 501. In addition, the check valve 504b is arranged so that a part thereof can move rightward in the drawing in a space 512b formed in the intermediate portion of the pump discharge hole 502.

When the pump chamber 503 is depressurized due to the diaphragm 506 being displaced and the capacity of the pump chamber 503 being increased, the check valve 504a separates from an opening of the pump supply hole 501 inside of the space 512a (in other words, moves leftward in the drawing). Due to the check valve 504a separating from the opening of the pump supply hole 501 inside of the space 512a, the open state is created where distribution of ink in the pump supply hole 501 is enabled. In addition, when the pump chamber 503 is pressurized due to the diaphragm 506 being displaced and the capacity of the pump chamber 503 being reduced, the check valve 504a comes into close contact with a wall surface in a periphery of the opening of the pump supply hole 501. As a result, the closed state is created where the distribution of ink in the pump supply hole 501 is shut off.

On the other hand, when the pump chamber 503 is depressurized, the check valve 504b comes into close contact with a wall surface in a periphery of the opening of the pump housing 505 and creates the closed state where the distribution of ink in the pump discharge hole 502 is shut off. In addition, when the pump chamber 503 is pressurized, the check valve 504b separates from the opening of the pump housing 505 and moves to a side of the space 512b (in other words, moves rightward in the drawing) and distribution of ink in the pump discharge hole 502 is enabled.

A material of each of the check valves 504a and 504b need only be deformable in response to pressure inside of the pump chamber 503 and, for example, the check valves 504a and 504b can be formed using an elastic member such as EPDM or an elastomer a film or a thin plate of polypropylene or the like. However, the material of the check valves 504a and 504b is not limited to the above.

As described earlier, the pump chamber 503 is formed by bonding the pump housing 505 and the diaphragm 506 to each other. Therefore, pressure inside of the pump chamber 503 changes when the diaphragm 506 deforms. For example, when the diaphragm 506 is displaced toward the side of the pump housing 505 (displaced rightward in FIG. 9) and the capacity of the pump chamber 503 decreases, the pressure inside of the pump chamber 503 rises. Accordingly, the check valve 504b arranged so as to oppose the pump discharge hole 502 changes to the open state and ink in the pump chamber 503 is discharged. At this point, since the check valve 504a arranged so as to oppose the pump supply hole 501 comes into close contact with the wall surface in the periphery of the pump supply hole 501, a counterflow of ink from the pump chamber 503 into the pump supply hole 501 is suppressed.

In addition, conversely, when the diaphragm 506 is displaced in a direction in which the pump chamber 503 expands, the pressure in the pump chamber 503 decreases. Accordingly, the check valve 504a arranged so as to oppose the pump supply hole 501 changes to the open state and ink is supplied to the pump chamber 503. At this point, the check valve 504b arranged in the pump discharge hole 502 comes into close contact with the wall surface in the periphery of an opening formed in the pump housing 505 and blocks the opening. Therefore, a counterflow of ink from the pump discharge hole 502 to the pump chamber 503 is suppressed.

In this manner, in the circulation pump 500, suction and discharge of ink are performed due to the deformation of the diaphragm 506 causing the pressure inside of the pump chamber 503 to change. In doing so, when bubbles enter the pump chamber 503, a pressure change in the pump chamber 503 decreases due to expansion and contraction of the bubbles even if the diaphragm 506 is displaced and an amount of fed liquid is reduced. In consideration thereof, the pump chamber 503 is arranged parallel to gravity in order to facilitate collection of bubbles having entered the pump chamber 503 to an upper part of the pump chamber 503 and, at the same time, the pump discharge hole 502 is arranged above a center of the pump chamber 503. Accordingly, discharge characteristics of bubbles inside of the pump can be improved and a flow rate can be stabilized.

### Flow of Ink Into Liquid Discharge Head

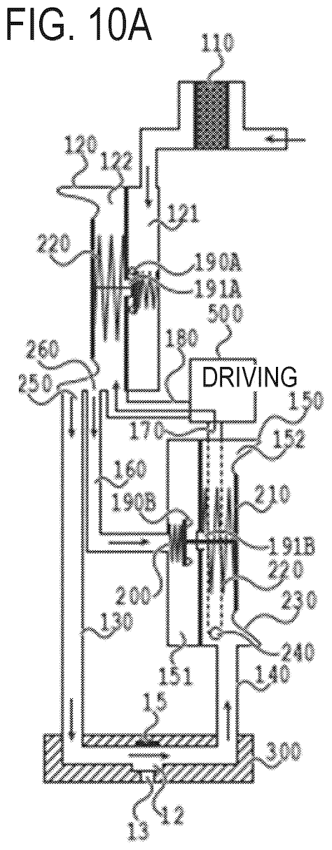

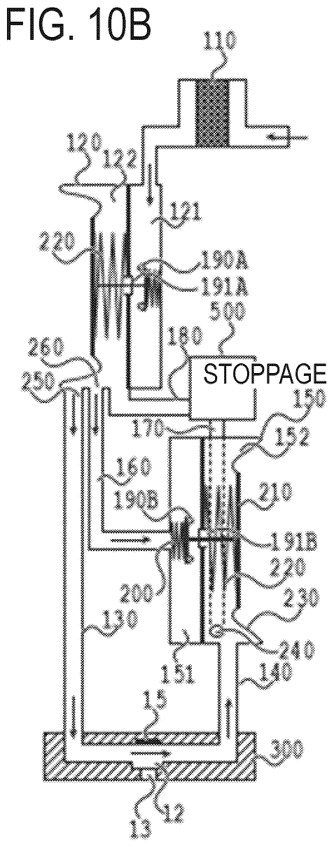

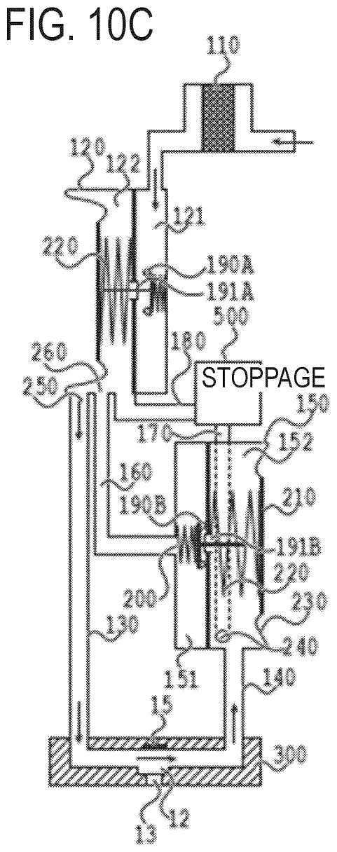

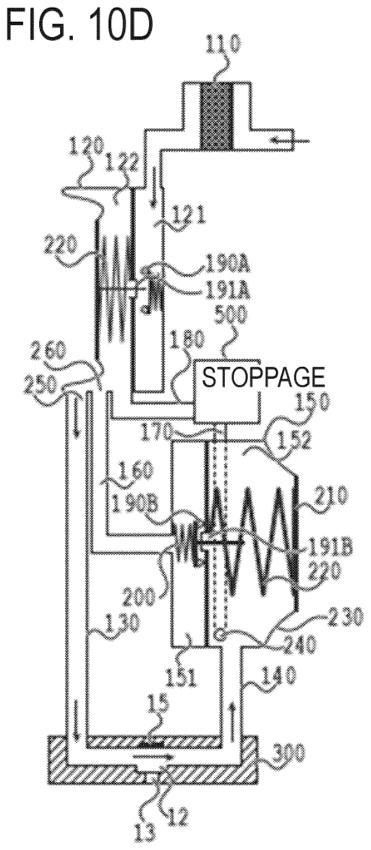

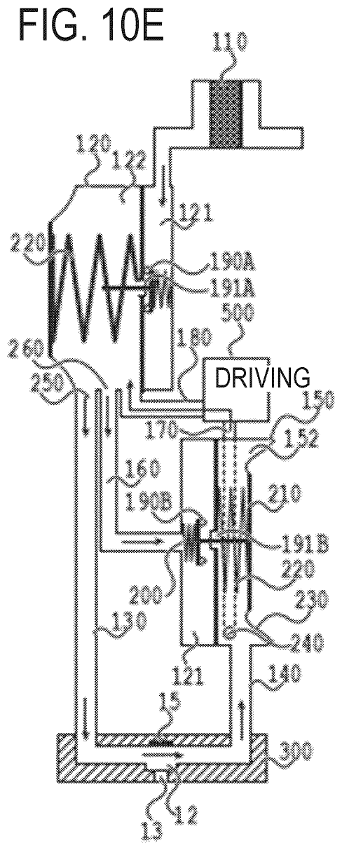

FIGS. 10A to 10E are diagrams illustrating flow of ink into the liquid discharge head. The circulation of ink performed in the liquid discharge head 1 will now be described with reference to FIGS. 10A to 10E. In order to describe the ink circulatory pathway in a clearer manner, the relative positions of the respective components (the first pressure adjusting unit 120, the second pressure adjusting unit 150, the circulation pump 500, and the like) in FIGS. 10A to 10E are shown in a simplified manner. Therefore, the relative positions of the respective components may differ from the configuration shown in FIG. 19 to be described later. FIG. 10A schematically shows flow of ink when performing a recording operation in which ink is discharged from the discharge port 13 and recording is performed. Arrows in the drawing depict flow of ink. In the present embodiment, when performing a recording operation, driving of both the external pump 21 and the circulation pump 500 is started. The external pump 21 and the circulation pump 500 may be driven regardless of a recording operation. In addition, driving of the external pump 21 and driving of the circulation pump 500 may be performed in an interlinked manner or each of the external pump 21 and the circulation pump 500 may be independently driven.

During a recording operation, the circulation pump 500 is in an ON state (driven state) and ink having flowed out from the first pressure control chamber 122 flows into the supply flow path 130 and the bypass flow path 160. The ink having flowed into the supply flow path 130 passes through the discharge module 300, flows into the recovery flow path 140, and is subsequently supplied to the second pressure control chamber 152.

On the other hand, the ink having flowed into the bypass flow path 160 from the first pressure control chamber 122 flows into the second pressure control chamber 152 via the second valve chamber 151. The ink having flowed into the second pressure control chamber 152 passes through the pump inlet flow path 170, the circulation pump 500, and the pump outlet flow path 180, and subsequently once again flows into the first pressure control chamber 122. At this point, control pressure due to the first valve chamber 121 is set higher than control pressure of the first pressure control chamber 122 based on the relation represented by Equation 2 described earlier. Therefore, the ink inside of the first pressure control chamber 122 is supplied to the discharge module 300 once again via the supply flow path 130 instead of flowing into the first valve chamber 121. The ink having flowed into the discharge module 300 passes the recovery flow path 140, the second pressure control chamber 152, the pump inlet flow path 170, the circulation pump 500, and the pump outlet flow path 180, and subsequently once again flows into the first pressure control chamber 122. Accordingly, ink circulation which is contained inside of the liquid discharge head 1 is performed.

In the ink circulation described above, a circulation amount (flow rate) of ink inside of the discharge module 300 is determined by differential pressure between the control pressure of the first pressure control chamber 122 and the control pressure of the second pressure control chamber 152. In addition, the differential pressure is set so as to realize a circulation amount that enables thickening of ink in a vicinity of a discharge port in the discharge module 300 to be suppressed. Ink corresponding to an amount consumed by recording is supplied from the ink tank 2 to the first pressure control chamber 122 via the filter 110 and the first valve chamber 121. A mechanism by which consumed ink is supplied will now be described in detail. Due to a decrease in ink from inside of the circulatory path by exactly the amount of ink consumed by the recording, the pressure inside of the first pressure control chamber drops and, consequently, the ink inside of the first pressure control chamber 122 also decreases. With the decrease in ink in the first pressure control chamber 122, an inner capacity of the first pressure control chamber 122 decreases. Due to the decrease in the inner capacity of the first pressure control chamber 122, the communication port 191A changes to the open state and ink is supplied from the first valve chamber 121 to the first pressure control chamber 122. The supplied ink is subjected to pressure loss when passing through the communication port 191A from the first valve chamber 121 and, by flowing into the first pressure control chamber 122, ink at positive pressure is switched to a negative-pressure state. In addition, due to the ink flowing into the first pressure control chamber 122 from the first valve chamber 121, a rise in the pressure in the first pressure control chamber causes the inner capacity of the first pressure control chamber to increase and the communication port 191A changes to the closed state. In this manner, the communication port 191A repetitively assumes the open state and the closed state in accordance with the consumption of ink. In addition, when ink is not consumed, the communication port 191A is kept in the closed state.

FIG. 10B schematically shows flow of ink immediately after the recording operation is finished and the circulation pump 500 is changed to an OFF state (stopped state). At a time point where the recording operation is finished and the circulation pump 500 is changed to OFF, both the pressure in the first pressure control chamber 122 and the pressure in the second pressure control chamber 152 are at the control pressure applied during a recording operation. Therefore, a movement of ink such as that shown in FIG. 10B occurs in accordance with the differential pressure between the pressure in the first pressure control chamber 122 and the pressure in the second pressure control chamber 152. Specifically, flow of ink is continuously generated in which the ink is supplied from the first pressure control chamber 122 to the discharge module 300 via the supply flow path 130 and the ink subsequently reaches the second pressure control chamber 152 via the recovery flow path 140. In addition, flow of ink from the first pressure control chamber 122 to the second pressure control chamber 152 via the bypass flow path 160 and the second valve chamber 151 is also continuously generated.

Due to the ink flows described above, an amount of ink having moved to the second pressure control chamber 152 from the first pressure control chamber 122 is supplied from the ink tank 2 to the first pressure control chamber 122 via the filter 110 and the first valve chamber 121. Therefore, an inner capacity of the first pressure control chamber 122 is kept constant. On the basis of the relationship represented by Equation 2, above, when the inner capacity of the first pressure control chamber 122 is constant, the spring force F1 of the valve spring 200, the spring force F2 of the pressure adjustment spring 220, the pressure-receiving area S1 of the valve 190, and the pressure-receiving area S2 of the pressure plate 210 are kept constant. Therefore, the pressure of the first pressure control chamber 122 is determined in accordance with a change in the pressure (gauge pressure) P1 of the first valve chamber 121. Accordingly, when the pressure P1 of the first valve chamber 121 does not change, the pressure P2 of the first pressure control chamber 122 is kept at the same pressure as the control pressure during a recording operation.

On the other hand, the pressure of the second pressure control chamber 152 changes over time in accordance with a change in inner capacity that accompanies an inflow of ink from the first pressure control chamber 122. Specifically, during a period from the state shown in FIG. 10B to the communication port 191 changing to the closed state and the second valve chamber 151 and the second pressure control chamber 152 entering a non-communicated state as shown in FIG. 10C, the pressure of the second pressure control chamber 152 changes in accordance with Equation 2. Subsequently, the pressure plate 210 and the valve shaft 190a change into a non-abutting state and the communication port 191 changes to the closed state. In addition, as shown in FIG. 10D, ink flows into the second pressure control chamber 152 from the recovery flow path 140. During a period from the pressure plate 210 and the flexible member 230 being displaced by the ink inflow to the inner capacity of the second pressure control chamber 152 reaching a maximum value, the pressure of the second pressure control chamber 152 changes in accordance with Equation 4. In other words, the pressure rises.

Once the state shown in FIG. 10C is created, flow of ink from the first pressure control chamber 122 to the second pressure control chamber 152 via the bypass flow path 160 and the second valve chamber 151 is not generated. Therefore, only flow of ink in which the ink inside of the first pressure control chamber 122 is supplied to the discharge module 300 via the supply flow path 130 and subsequently reaches the second pressure control chamber 152 via the recovery flow path 140 is generated. As described earlier, the movement of ink from the first pressure control chamber 122 to the second pressure control chamber 152 occurs in accordance with differential pressure between the pressure in the first pressure control chamber 122 and the pressure in the second pressure control chamber 152. Therefore, the movement of the ink stops when the pressure in the first pressure control chamber 122 becomes equal to the pressure in the second pressure control chamber 152.

In addition, in a state where the pressure in the second pressure control chamber 152 is equal to the pressure in the first pressure control chamber 122, the second pressure control chamber 152 expands until reaching the state shown in FIG. 10D. When the second pressure control chamber 152 has expanded as shown in FIG. 10D, a storage portion capable of storing ink is formed in the second pressure control chamber 152. While a transition from a stoppage of the circulation pump 500 to the state shown in FIG. 10D may vary according to shapes and sizes of flow paths and characteristics of ink, the transition generally takes around one to two minutes. When the circulation pump 500 is driven from the state shown in FIG. 10D where ink is stored in the storage portion, the ink in the storage portion is supplied to the first pressure control chamber 122 by the circulation pump 500. Accordingly, as shown in FIG. 10E, an amount of ink in the first pressure control chamber 122 increases and the flexible member 230 and the pressure plate 210 are displaced in an expanding direction. In addition, when driving of the circulation pump 500 is continuously performed, the state in the circulatory path is to change as shown in FIG. 10A.

While FIG. 10A has been described as an example during a recording operation in the description given above, the circulation of ink may be performed without being accompanied by a recording operation as described earlier. Even in this case, flow of ink such as that shown in FIGS. 10A to 10E is to be created in accordance with driving and stoppage of the circulation pump 500.

In addition, as described above, while an example where the communication port 191B in the second pressure adjusting unit 150 changes to the open state when the circulation pump 500 is driven and circulation of ink is performed and changes to the closed state when the circulation of ink stops is used in the present embodiment, the communication port 191B is not limited thereto. Control pressure may be set so that the communication port 191B in the second pressure adjusting unit 150 remains in the closed state even when the circulation pump 500 is driven and circulation of ink is performed. Hereinafter, a specific description will be given together with a description of the function of the bypass flow path 160.

The bypass flow path 160 which connects the first pressure adjusting unit 120 and the second pressure adjusting unit 150 to each other is provided so that, for example, when negative pressure created in the circulatory path exceeds a prescribed value, the negative pressure does not affect the discharge module 300. In addition, the bypass flow path 160 is also provided in order to supply ink to the pressure chamber 12 from both the supply flow path 130 and the recovery flow path 140.

For example, when negative pressure exceeds a prescribed value, the negative pressure is prevented from affecting the discharge module 300 by providing the bypass flow path 160 will be described. Characteristics (for example, viscosity) of ink may change due to a change in environmental temperature. When the viscosity of ink changes, pressure loss inside of the circulatory path also changes. When the viscosity of ink drops, an amount of pressure loss inside of the circulatory path decreases. As a result, a flow rate of the circulation pump 500 being driven by a constant drive amount increases and a flow rate through the discharge module 300 also increases. On the other hand, since the discharge module 300 is kept at a constant temperature by a temperature adjustment mechanism, the viscosity of the ink inside of the discharge module 300 is kept constant even if the environmental temperature changes. Due to an increase in the flow rate of ink flowing through the discharge module 300 while the viscosity of the ink in the discharge module 300 remains unchanged, negative pressure in the discharge module 300 increases due to flow resistance. In this manner, when the negative pressure in the discharge module 300 exceeds a prescribed value, there is a risk that a meniscus of the discharge port 13 may break, outside air may be pulled into the circulatory path, and normal discharge may no longer be performed. In addition, even if the meniscus does not break, the negative pressure in the pressure chamber 12 may exceed prescribed pressure and may affect discharge.

Therefore, in the present embodiment, the bypass flow path 160 is formed in the circulatory path. Since providing the bypass flow path 160 causes ink to also flow into the bypass flow path 160 when the negative pressure exceeds a prescribed value, pressure of the discharge module 300 can be kept constant. Therefore, for example, the communication port 191B in the second pressure adjusting unit 150 may be configured with control pressure which enables the communication port 191B to remain in the closed state even when the circulation pump 500 is being driven. Control pressure in the second pressure adjusting unit 150 may be set so that the communication port 191 in the second pressure adjusting unit changes to the open state when the negative pressure exceeds a prescribed value. In other words, the communication port 191B may be in the closed state while the circulation pump 500 is being driven if the meniscus stays unbroken even when the flow rate of the pump changes due to a change in the environment such as a change in viscosity or when prescribed negative pressure is maintained.

Next, an example in which the bypass flow path 160 is provided in order to supply ink to the pressure chamber 12 from both the supply flow path 130 and the recovery flow path 140 will be described. A pressure fluctuation in the circulatory path may also occur due to a discharge operation by the discharge element 15. This is because a force that pulls ink into the pressure chamber is created with the discharge operation.

Hereinafter, a situation where ink supplied to the pressure chamber 12 is supplied from both the side of the supply flow path 130 and the side of the recovery flow path 140 when high-duty recording is continued will be described. While a definition of duty may change depending on various conditions, in this case, a state where one ink drop of 4 pl is recorded on a 1200 dpi lattice will be considered 100%. It is assumed that a high-duty recording is recording performed at a duty of, for example, 100%.

When high-duty recording is continued, an amount of ink that flows into the second pressure control chamber 152 from the pressure chamber 12 via the recovery flow path 140 decreases. On the other hand, since the circulation pump 500 creates an outflow of ink in a constant amount, a balance between inflow and outflow in the second pressure control chamber 152 is disrupted, the ink in the second pressure control chamber 152 decreases, the negative pressure in the second pressure control chamber 152 increases, and the second pressure control chamber 152 contracts. In addition, due to an increase in the negative pressure in the second pressure control chamber 152, an inflow amount of ink that flows into the second pressure control chamber 152 via the bypass flow path 160 increases and the second pressure control chamber 152 stabilizes in a balance state between outflow and inflow. In this manner, consequently, the negative pressure in the second pressure control chamber 152 rises in proportion with the duty. As described above, in a configuration in which the communication port 191B is in the closed state while the circulation pump 500 is being driven, the communication port 191B changes to the open state in accordance with the duty and ink is to flow into the second pressure control chamber 152 from the bypass flow path 160.

When high-duty recording is continued, an amount of ink that flows into the second pressure control chamber 152 from the pressure chamber 12 via the recovery flow path 140 decreases and, instead, an amount of ink that flows into the second pressure control chamber 152 from the communication port 191B via the bypass flow path 160 increases. When this state further continues, the amount of ink that flows into the second pressure control chamber 152 from the pressure chamber 12 via the recovery flow path 140 drops to zero and the ink that flows into the circulation pump 500 becomes entirely constituted of ink that flows in from the communication port 191B. When this state further continues, in turn, ink flows in reverse from the second pressure control chamber 152 into the pressure chamber 12 via the recovery flow path 140. In this state, ink that flows out from the second pressure control chamber 152 to the circulation pump 500 and ink that flows out from the second pressure control chamber 152 to the pressure chamber 12 are to flow into the second pressure control chamber 152 from the communication port 191B through the bypass flow path 160. In this case, the pressure chamber 12 is to be filled by the ink of the supply flow path 130 and the ink of the recovery flow path 140 and the filled ink is to be discharged from the pressure chamber 12.

The counterflow of ink which is created when the recording duty is high is a phenomenon that occurs due to the presence of the bypass flow path 160. In addition, while an example where the communication port 191B in the second pressure adjusting unit changes to the open state in accordance with a counterflow of ink has been described earlier, a counterflow of ink may also occur in a state where the communication port 191B in the second pressure adjusting unit is already in the open state. Due to the presence of the bypass flow path 160, the counterflow of ink described earlier may occur even in a configuration where the second pressure adjusting unit is not provided.

### Discharge Unit

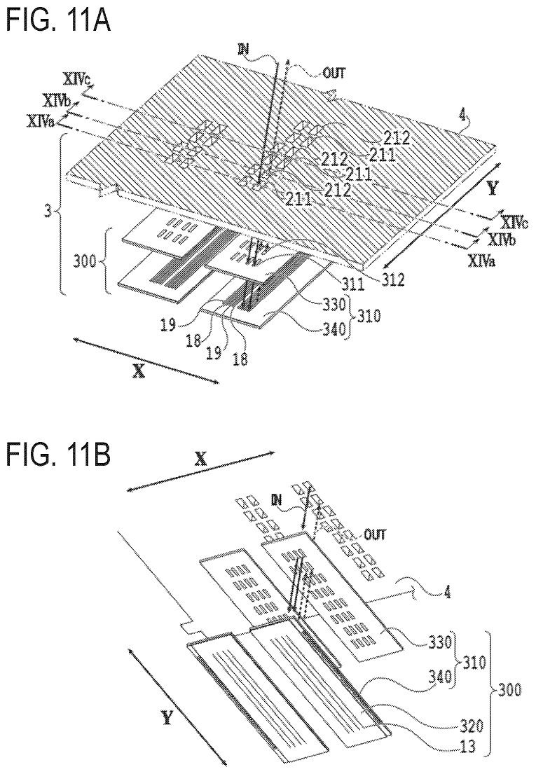

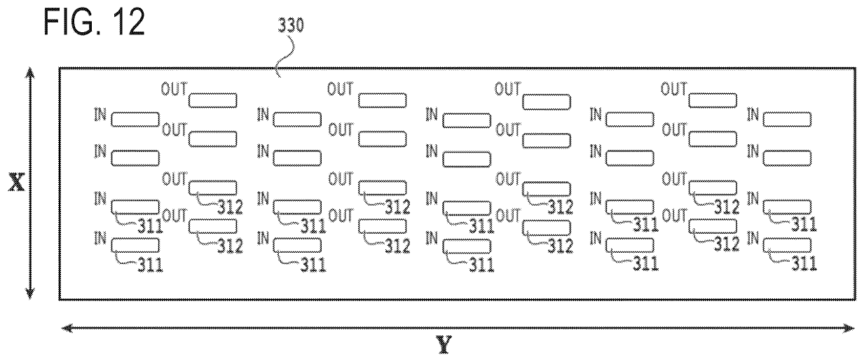

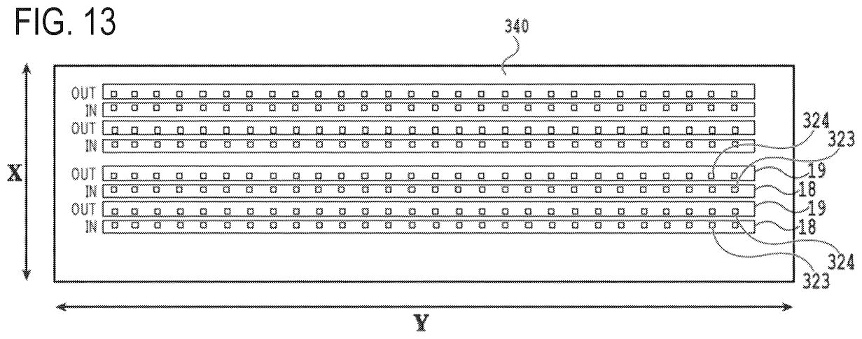

FIGS. 11A and 11B are schematic views showing a circulatory pathway for one ink color in the discharge unit 3 according to the present embodiment. FIG. 11A is an exploded perspective view when the discharge unit 3 is viewed from a side of the first supporting member 4 and FIG. 11B is an exploded perspective view when the discharge unit 3 is viewed from a side of the discharge module 300. Arrows labeled IN and OUT in the diagram indicate ink flow, and although only one color is shown here, the flow for other colors is identical. For clarity and conciseness, descriptions of the second supporting member 7 and the electric wiring member 5 are not shown in FIGS. 11A and 11B as well as in the description of the components of the discharge unit provided below. FIG. 11A shows a cross section along XI-XI in FIGS. 3A and 3B of the first supporting member 4. The discharge module 300 includes a discharge element substrate 340 and an opening plate 330. FIG. 12 is a diagram showing the opening plate 330 and FIG. 13 is a diagram showing the discharge element substrate 340.

Ink is supplied to the discharge unit 3 from the circulation unit 54 via the joint member 8 (FIGS. 3A and 3B). A pathway of ink from a point where the ink passes through the joint member 8 until the ink returns to the joint member 8 will be described. For clarity, the description of the joint member 8 is not shown in subsequent drawings.

The discharge module 300 includes the discharge element substrate 340 and the opening plate 330 that constitutes the silicon substrate 310 and further includes the discharge port forming member 320. The discharge element substrate 340, the opening plate 330, and the discharge port forming member 320 are stacked and joined together so that the flow paths for each ink are communicated, thereby forming the discharge module 300 that is supported by the first supporting member 4. The discharge module 300 is supported by the first supporting member 4, thereby forming the discharge unit 3. The discharge element substrate 340 includes the discharge port forming member 320, the discharge port forming member 320 includes a plurality of discharge port arrays that are arrays of pluralities of the discharge ports 13, and a part of the ink supplied via the ink flow path in the discharge module 300 is discharged from the discharge ports 13. Ink that was not discharged is recovered via the ink flow path in the discharge module 300.

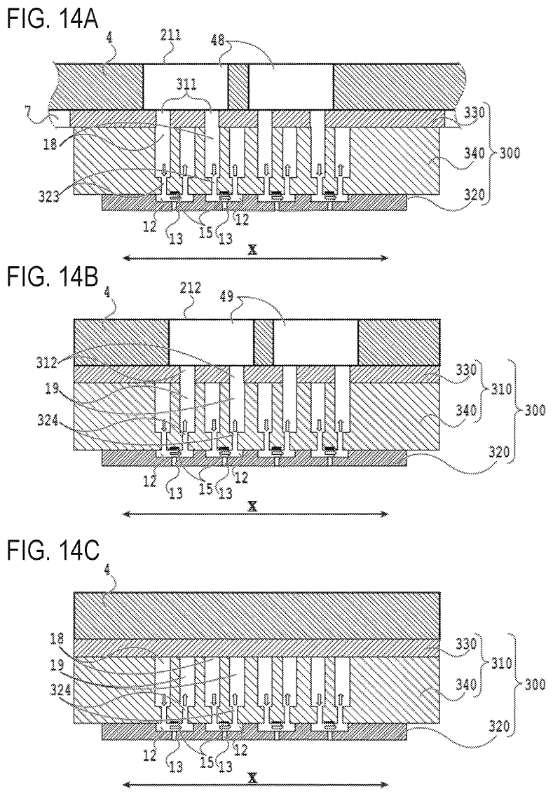

As shown in FIGS. 11A, 11B, and 12, the opening plate 330 includes a plurality of arrayed ink supply ports 311 and a plurality of arrayed ink recovery ports 312. As shown in FIGS. 13 and 14A to 14C, the discharge element substrate 340 includes a plurality of arrayed supply connection flow paths 323 and a plurality of arrayed recovery connection flow paths 324. The discharge element substrate 340 includes the common supply flow path 18 that communicates with the plurality of supply connection flow paths 323 and the common recovery flow path 19 that communicates with the plurality of recovery connection flow paths 324. The ink flow path in the discharge unit 3 is formed by communicating the ink supply flow path 48 and the ink recovery flow path 49 (FIGS. 3A and 3B) provided in the first supporting member 4 with the flow path provided in the discharge module 300. A supporting member supply port 211 is a cross-sectional opening that forms the ink supply flow path 48 and a supporting member recovery port 212 is a cross-sectional opening that forms the ink recovery flow path 49.

The ink supplied to the discharge unit 3 is supplied from the side of the circulation unit 54 (FIG. 3A) to the ink supply flow path 48 (FIG. 3A) of the first supporting member 4. The ink having flowed through the supporting member supply port 211 in the ink supply flow path 48 is supplied to the common supply flow path 18 of the discharge element substrate 340 via the ink supply flow path 48 (FIG. 3A) and the ink supply port 311 of the opening plate 330, and enters the supply connection flow path 323. This completes the supply-side flow path. Subsequently, the ink flows to the recovery connection flow path 324 of the recovery-side flow path via the pressure chamber 12 (FIG. 3B) of the discharge port forming member 320. Details of the flow of ink in the pressure chamber 12 will be provided later.

In the recovery-side flow path, the ink having entered the recovery connection flow path 324 flows to the common recovery flow path 19. Subsequently, the ink flows from the common recovery flow path 19 to the ink recovery flow path 49 of the first supporting member 4 via the ink recovery port 312 of the opening plate 330 and is recovered by the circulation unit 54 via the supporting member recovery port 212.

A region in the opening plate 330 in which the ink supply port 311 and the ink recovery port 312 are not present corresponds to a region for partitioning the supporting member supply port 211 and the supporting member recovery port 212 in the first supporting member 4. In addition, the region also does not have an opening in the first supporting member 4. Such region is used as a bonding region when the discharge module 300 and the first supporting member 4 are bonded to each other.

In the opening plate 330 shown in FIG. 12, an array of a plurality of openings arrayed in the X direction are provided in plurality in the Y direction, and openings for supply (IN) and openings for recovery (OUT) are alternately arrayed in the Y direction so the openings are offset by half a pitch in the X direction. In the discharge element substrate 340 shown in FIG. 13, the common supply flow path 18 that communicates with the plurality of supply connection flow paths 323 arrayed in the Y direction and the common recovery flow path 19 that communicates with the plurality of recovery connection flow paths 324 arrayed in the Y direction are alternately arrayed in the X direction. The common supply flow path 18 and the common recovery flow path 19 are separated for each type of ink and the number of arranged common supply flow paths 18 and the number of arranged common recovery flow paths 19 are determined according to the number of discharge port arrays for each color. In addition, the supply connection flow path 323 and the recovery connection flow path 324 are also arranged in numbers corresponding to the number of discharge ports 13. A one-to-one correspondence is not necessarily required and a single supply connection flow path 323 and a single recovery connection flow path 324 may correspond to a plurality of discharge ports 13.

The opening plate 330 and the discharge element substrate 340 configured as described above are stacked and joined together so that the flow paths for each ink are communicated to form the discharge module 300, and by supporting the discharge module 300 with the first supporting member 4, the ink flow path including a supply flow path and the recovery flow path as described above is formed.

FIGS. 14A to 14C are sectional views showing flow of ink in a different portion of the discharge unit 3. FIG. 14A is a cross section along XIVa-XIVa in FIG. 11A and shows a cross section of a portion where the ink supply flow path 48 and the ink supply port 311 in the discharge unit 3 are communicated with each other. In addition, FIG. 14B is a cross section along XIVb-XIVb in FIG. 11A and shows a cross section of a portion where the ink recovery flow path 49 and the ink recovery port 312 in the discharge unit 3 are communicated with each other. FIG. 14C is a cross section along XIVc-XIVc in FIG. 11A and shows a cross section of a portion where the ink supply port 311 and the ink recovery port 312 are not communicated with the flow path of the first supporting member 4.

In the supply flow path for supplying ink, as in FIG. 14A, ink is supplied from a portion where the ink supply flow path 48 of the first supporting member 4 and the ink supply port 311 of the opening plate 330 overlaps with and communicate with each other. In addition, in the recovery flow path for recovering ink, as in FIG. 14B, ink is recovered from a portion where the ink recovery flow path 49 of the first supporting member 4 and the ink recovery port 312 of the opening plate 330 overlap with and communicate with each other. As illustrated in FIG. 14C, the discharge unit 3 includes partial regions where the opening plate 330 is not provided with an opening. In such region, ink is neither supplied nor recovered between the discharge element substrate 340 and the first supporting member 4. Ink is supplied in a region where the ink supply port 311 is provided as in FIG. 14A and ink is recovered in a region where the ink recovery port 312 is provided as in FIG. 14B. While a configuration using the opening plate 330 has been described as an example in the present embodiment, a configuration that does not use the opening plate 330 may also be adopted. For example, a configuration may be adopted in which a flow path corresponding to the ink supply flow path 48 and the ink recovery flow path 49 are formed in the first supporting member 4 and the discharge element substrate 340 is joined with the first supporting member 4.

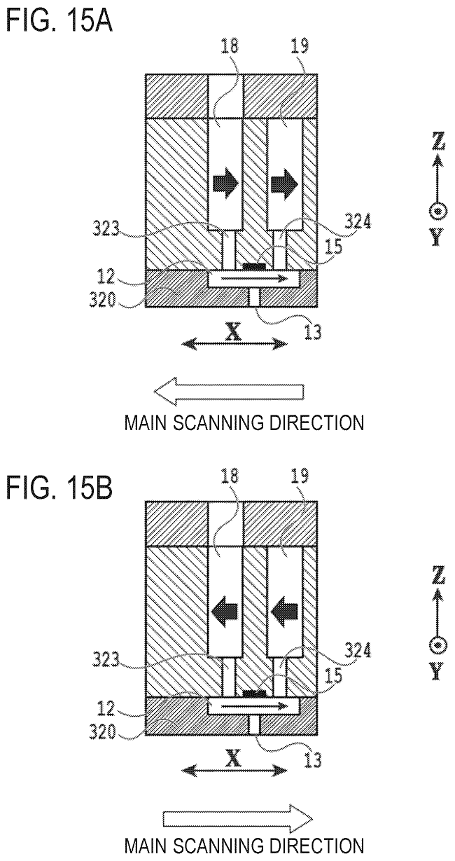

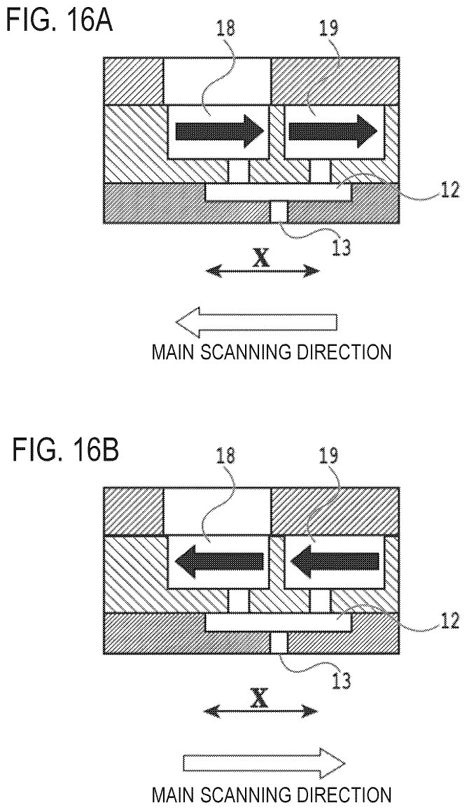

FIGS. 15A and 15B are sectional views showing a vicinity of the discharge port 13 in the discharge module 300, and FIGS. 16A and 16B are sectional views showing a discharge module configured such that the common supply flow path 18 and the common recovery flow path 19 are expanded in the X direction as a comparative example. Bold arrows shown in the common supply flow path 18 and the common recovery flow path 19 in FIGS. 15A and 15B and FIGS. 16A and 16B indicate oscillation of ink in a configuration using a serial-type liquid discharge apparatus 50. The ink supplied to the pressure chamber 12 via the common supply flow path 18 and the supply connection flow path 323 is discharged from the discharge port 13 due to driving of the discharge element 15. When the discharge element 15 is not driven, the ink is recovered from the pressure chamber 12 to the common recovery flow path 19 via the recovery connection flow path 324 that is a recovery flow path.

When discharge of ink circulating as described above is performed in a mode that uses a serial-type liquid discharge apparatus 50, the discharge of ink is significantly affected by the oscillation of ink in the ink flow path caused by main scanning of the liquid discharge head 1. Specifically, the effects of oscillation of ink in the ink flow path may manifest as differences in ink discharge volume or deviations in a discharge direction. When the common supply flow path 18 and the common recovery flow path 19 have cross-sectional shapes that are wide in the X direction, which is the main scanning direction, as shown in FIGS. 16A and 16B, the ink in the common supply flow path 18 and the common recovery flow path 19 becomes prone to an inertial force in the main scanning direction and significant oscillation is imparted to the ink. As a result, there is a risk that the oscillation of ink may affect discharge of ink from the discharge port 13. Widening the common supply flow path 18 and the common recovery flow path 19 in the X direction increases the distance between colors, potentially reducing printing efficiency.

In consideration thereof, the common supply flow path 18 and the common recovery flow path 19 according to the present embodiment are both configured to extend in the Y direction and also extend in the Z direction that is perpendicular to the X direction being the main scanning direction in the cross sections shown in FIGS. 15A and 15B. Adopting such a configuration enables the respective flow path widths of the common supply flow path 18 and the common recovery flow path 19 in the main scanning direction to be reduced. Reducing the respective flow path widths of the common supply flow path 18 and the common recovery flow path 19 in the main scanning direction reduces oscillation of ink due to an inertial force (black bold arrow in the diagram) acting in a direction opposite to the main scanning direction on the ink in the common supply flow path 18 and the common recovery flow path 19 during main scanning. Accordingly, an effect of the oscillation of ink on the discharge of ink can be suppressed. In addition, sectional areas are increased by extending the common supply flow path 18 and the common recovery flow path 19 in the Z direction, thereby reducing flow path pressure loss.

As described above, while a configuration is adopted in which oscillation of ink in the common supply flow path 18 and the common recovery flow path 19 during main scanning is reduced by reducing the respective flow path widths of the common supply flow path 18 and the common recovery flow path 19 in the main scanning direction, this does not mean that the oscillation will stop. In consideration thereof, in order to suppress differences in discharge that may still occur for each ink type even with reduced oscillation, in the present embodiment, the common supply flow path 18 and the common recovery flow path 19 are configured to be arranged at overlapping positions in the X direction.

As described earlier, in the present embodiment, the supply connection flow path 323 and the recovery connection flow path 324 are provided so as to correspond to the discharge port 13, and the supply connection flow path 323 and the recovery connection flow path 324 are arranged in a correspondence relationship of being arranged side by side in the X direction with the discharge port 13 therebetween. Therefore, there is a portion where the common supply flow path 18 and the common recovery flow path 19 do not overlap with each other in the X direction, and when the correspondence relationship between the supply connection flow path 323 and the recovery connection flow path 324 in the X direction breaks down, the flow of ink in the X direction in the pressure chamber 12 and discharge of ink are affected. If the effect of oscillation of ink is added thereto, there is a risk that the discharge of ink from each discharge port may become further affected.

Therefore, arranging the common supply flow path 18 and the common recovery flow path 19 at overlapping positions in the X direction enables oscillation of ink during main scanning in the common supply flow path 18 and the common recovery flow path 19 to be approximately equivalent at any position in the Y direction in which the discharge ports 13 are arrayed. As a result, the pressure difference between the side of the common supply flow path 18 and the side of the common recovery flow path 19 in the pressure chamber 12 does not fluctuate significantly, enabling stable discharge.

In addition, while some liquid discharge heads that circulate ink are configured to use the same flow path for both supplying ink to the liquid discharge head and recovering ink, in the present embodiment, the common supply flow path 18 and the common recovery flow path 19 are configured as separate flow paths. In addition, the supply connection flow path 323 and the pressure chamber 12 are communicated with each other, the pressure chamber 12 and the recovery connection flow path 324 are communicated with each other, and ink is discharged from the discharge ports 13 of the pressure chamber 12. In other words, the pressure chamber 12 that serves as a pathway connecting the supply connection flow path 323 and the recovery connection flow path 324 is configured to include the discharge ports 13. Therefore, flow of ink from the side of the supply connection flow path 323 to the side of the recovery connection flow path 324 is created in the pressure chamber 12 and the ink in the pressure chamber 12 is efficiently circulated. By efficiently circulating the ink in the pressure chamber 12, the ink in the pressure chamber 12 that is likely to be affected by evaporation of ink from the discharge ports 13 can be maintained in a fresh state.

In addition, due to the two flow paths, the common supply flow path 18 and the common recovery flow path 19, communicating with the pressure chamber 12, when ink needs to be discharged at a high flow rate, ink can also be supplied from both flow paths. In other words, compared to a configuration in which a single flow path is used for both supply and recovery of ink, the configuration according to the present embodiment not only enables efficient circulation but also has an advantage of being able to accommodate discharge at a high flow rate.

In addition, the common supply flow path 18 and the common recovery flow path 19 are less susceptible to the effects of oscillation of ink when positioned closer together in the X direction. A spacing between flow paths may be between 75 to 100 μm.

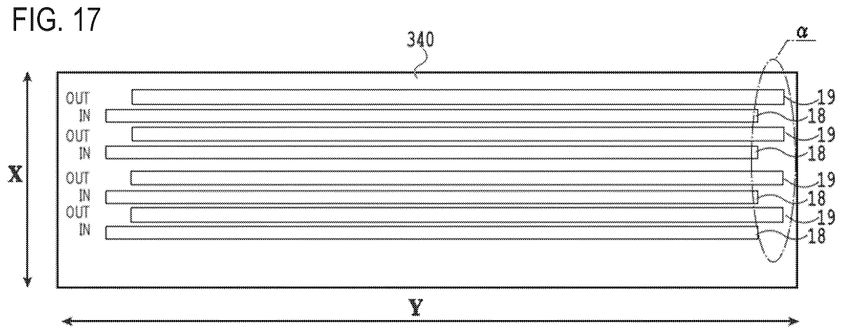

FIG. 17 is a diagram showing the discharge element substrate 340 as a comparative example. For clarity, the description of the supply connection flow path 323 and the recovery connection flow path 324 is not shown in FIG. 17. Since ink that has received heat energy from the discharge element 15 in the pressure chamber 12 flows into the common recovery flow path 19, ink flowing through this channel is relatively hotter than the ink in the common supply flow path 18. At this time, in the comparative example, as shown in an α portion enclosed by a dashed-dotted line in FIG. 17, there is a portion where only the common recovery flow path 19 exists in a portion of the discharge element substrate 340 in the X direction. In this case, the temperature locally increases in the portion, causing temperature variations within the discharge module 300, which may affect discharge performance.

Ink with a relatively low temperature relative to the common recovery flow path 19 flows through the common supply flow path 18. Accordingly, when the common supply flow path 18 and the common recovery flow path 19 are adjacent to each other, an increase in temperature can be suppressed in a vicinity thereof since the temperatures of the common supply flow path 18 and the common recovery flow path 19 partially offset each other. Therefore, the common supply flow path 18 and the common recovery flow path 19 may have substantially equal lengths, at positions overlapping each other in the X direction, adjacent to each other.

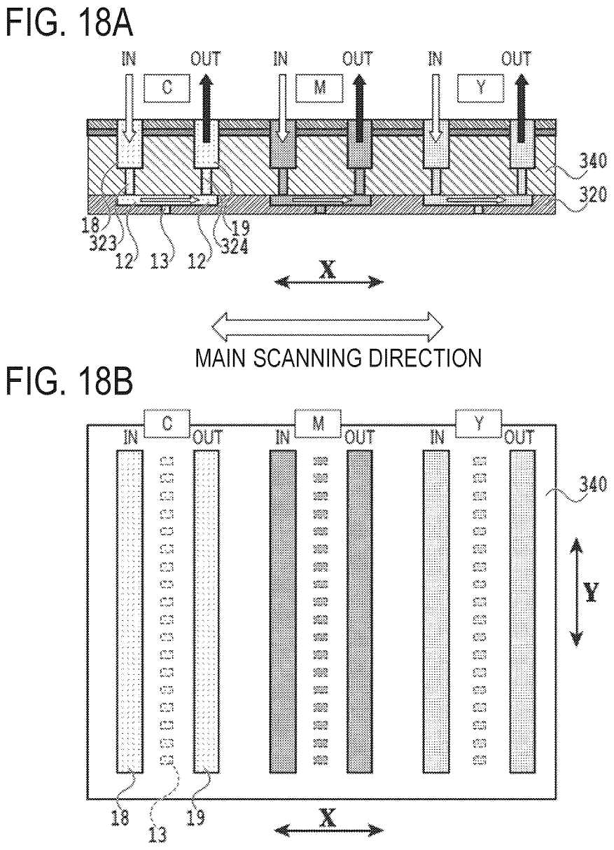

FIGS. 18A and 18B are diagrams showing a flow path configuration of the liquid discharge head 1 corresponding inks of the three colors of cyan (C), magenta (M), and yellow (Y). The liquid discharge head 1 is provided with a circulatory flow path for each type of ink as shown in FIG. 18A. The pressure chamber 12 is provided along the X direction that is a main scanning direction of the liquid discharge head 1. In addition, as in FIG. 18B, the common supply flow path 18 and the common recovery flow path 19 are provided along the discharge port array being an array of the discharge ports 13 and are provided extending in the Y direction so that the discharge port array is sandwiched between the common supply flow path 18 and the common recovery flow path 19.

### Connection Between Main Body Portion and Liquid Discharge Head

FIG. 19 is a schematic configuration diagram showing, in greater detail, a connection state among the ink tank 2 provided in the main body portion of the liquid discharge apparatus 50 according to the present embodiment, the external pump 21, and the liquid discharge head 1, and arrangements of the circulation pump and the like. The liquid discharge apparatus 50 according to the present embodiment includes a component that enables only the liquid discharge head 1 to be replaced when a defect occurs in the liquid discharge head 1. Specifically, the liquid discharge apparatus 50 includes a liquid connecting portion 700 that enables easy connection and disconnection between the ink supply tube 59 connected to the external pump 21 and the liquid discharge head 1. Accordingly, only the liquid discharge head 1 can be readily attached and detached to and from the liquid discharge apparatus 50.

As shown in FIG. 19, the liquid connecting portion 700 includes a liquid connector insertion opening 53a protruding from the head housing 53 of the liquid discharge head 1 and a cylindrical liquid connector 59a that can be inserted into the liquid connector insertion opening 53a. The liquid connector insertion opening 53a is fluidically connected to the ink supply flow path formed in the liquid discharge head 1 and connected to the first pressure adjusting unit 120 via the filter 110 described earlier. In addition, the liquid connector 59a is provided at a leading end of the ink supply tube 59 connected to the external pump 21 that pressurizes the ink in the ink tank 2 and supplies the ink to the liquid discharge head 1.

As described above, in the liquid discharge head 1 shown in FIG. 19, the liquid connecting portion 700 enables attachment/detachment and replacement operations of the liquid discharge head 1 to be readily performed. However, when sealing performance between the liquid connector insertion opening 53a and the liquid connector 59a declines, there is a risk that ink pressurized and supplied by the external pump 21 may leak out from the liquid connecting portion 700. If leaked ink adheres to the circulation pump 500 and the like, the ink may cause electrical system malfunctions. In consideration thereof, the circulation pump and the like are arranged as follows.

### Arrangement of Circulation Pump and the Like

As shown in FIG. 19, in the present embodiment, the circulation pump 500 is arranged above the liquid connecting portion 700 in the direction of gravitational force in order to prevent ink having leaked from the liquid connecting portion 700 from adhering to the circulation pump 500. In other words, the circulation pump 500 is arranged above the liquid connector insertion opening 53a that is a feed port of liquid of the liquid discharge head 1 in the direction of gravitational force. The circulation pump 500 is arranged at a position where the circulation pump 500 is not in contact with members that constitute the liquid connecting portion 700. Accordingly, even if ink leaks out from the liquid connecting portion 700, since ink flows in a horizontal direction that is an opening direction of the liquid connector 59a or downward in the direction of gravitational force, ink can be prevented from reaching the circulation pump 500 that is above in the direction of gravitational force. In addition, since the circulation pump 500 is arranged at a position separated from the liquid connecting portion 700, the likelihood of ink reaching the circulation pump 500 by traveling along the members is also reduced.

In addition, an electric connecting portion 515 that electrically connects the circulation pump 500 and the electric contact substrate 6 via a flexible wiring member 514 is provided above the liquid connecting portion 700 in the direction of gravitational force. Therefore, the potential for electrical problems caused by ink from the liquid connecting portion 700 can be reduced.

In the present embodiment, since a wall portion 52b of the head housing 53 is provided, even if ink is ejected from an opening 59b of the liquid connecting portion 700, the ink can be blocked and the possibility of the ink reaching the circulation pump 500 or the electric connecting portion 515 can be reduced.

Features of the present case will be described below. While a plurality of embodiments will be described hereinafter, common components will be assigned same reference signs and descriptions are not repeated, for clarity, and are incorporated by reference.

### First Embodiment

The liquid discharge head 1 according to a first embodiment of the present disclosure will be described. FIG. 20 is an exploded perspective view showing the liquid discharge head 1 according to the first embodiment. The liquid discharge head 1 includes the discharge unit 3 that discharges ink, a tank holder unit 20 that functions as a supply unit for supplying a liquid to the discharge unit 3, and a sealing member 30 that is sandwiched by the discharge unit 3 and the tank holder unit 20. The liquid discharge head 1 is configured such that the discharge unit 3 and the tank holder unit 20 are coupled to each other using screws while sandwiching the sealing member 30 therebetween. For clarity, the circulation unit 54 to be mounted on the tank holder unit 20 is not illustrated in FIG. 20. In the first embodiment, the discharge unit 3 is provided with two discharge modules 300 and the liquid discharge head 1 is provided with two sealing member 30 that correspond to the number of discharge modules 300.

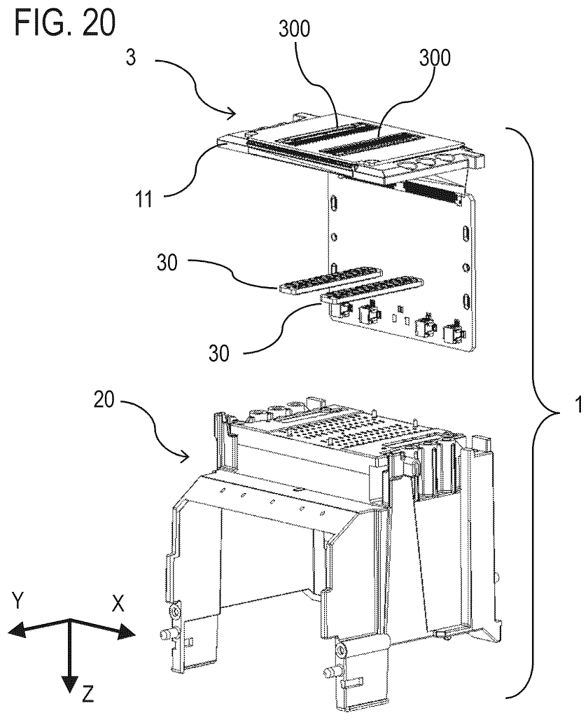

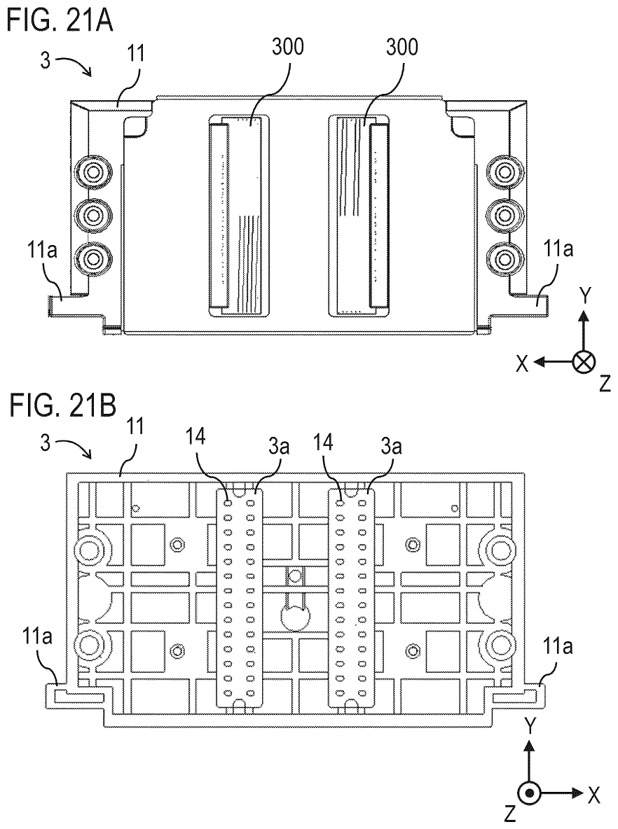

FIGS. 21A and 21B are explanatory diagrams of the discharge unit 3. FIG. 21A is a plan view of the discharge unit 3 and shows a surface of the discharge unit 3 that exposes the discharge modules 300. FIG. 21B is a plan view of the discharge unit 3 and shows a contact surface 3a that comes into contact with the sealing member 30. The contact surface 3a is a flat surface.

The discharge unit 3 includes a resin supporting plate 11 and the discharge modules 300 mounted on the supporting plate 11. Each discharge module 300 is a recording element substrate provided with discharge elements 15 that are energy generation elements. The discharge elements 15 can be, for example, heating elements. The discharge module 300 is provided with a plurality of discharge ports 13 corresponding to the discharge elements 15 and the discharge module 300 is configured to be capable of discharging a liquid such as ink from each discharge port 13.

The supporting plate 11 is a plate-shaped supporting member including the first supporting member 4 and the second supporting member 7 (FIG. 2) and the like. A plurality of first flow paths 14 through which ink passes are opened on the contact surface 3a of the supporting plate 11. Each first flow path 14 includes the supply port 88 and the recovery port 89 of the discharge unit 3 shown in FIG. 3A.

To stably discharge high-concentration ink in small droplets, the liquid discharge head 1 is configured to allow ink to circulate inside, and the first flow paths 14 are used for ink circulation. Since a plurality of flow paths are used for ink to circulate stably, a plurality of the first flow paths 14 are formed in the supporting plate 11. The plurality of (openings of) the first flow paths 14 are arranged aligned in an array in a column direction (Y direction) and constitute a flow path array. In the first embodiment, two flow path arrays are formed aligned in an intersecting direction (X direction) that intersects with the column direction so as to correspond to the two discharge modules 300, respectively.

The supporting plate 11 is provided with a positioning portion 11a for determining relative positions with the tank holder unit 20. The supporting plate 11 is provided with two positioning portions 11a, and each positioning portion 11a is provided at one end portion of the supporting plate 11 in the Y direction and at both end portions in the X direction.

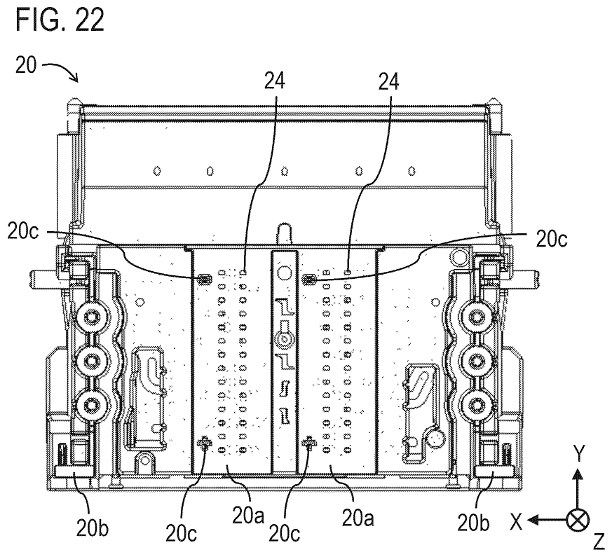

FIG. 22 is a plan view of the tank holder unit 20 and shows a contact surface 20a that comes into contact with the sealing member 30. The tank holder unit 20, as a supply unit, includes a plurality of circulation units 54 and the head housing 53 that is a holder on which the plurality of circulation units 54 are mounted. The liquid discharge head 1 is configured such that liquid circulates between the tank holder unit 20 and the discharge unit 3. A plurality of second flow paths 24 through which ink passes are formed in the tank holder unit 20. The plurality of (openings of) the second flow paths 24 are arranged aligned in an array in the Y direction and constitute a flow path array. In the first embodiment, two flow path arrays are formed aligned in the X direction so as to correspond to the two discharge modules 300, respectively.

The tank holder unit 20 is provided with a positioning portion 20b for determining relative positions with the supporting plate 11 and positioning pins 20c that are positioning portions for determining a mounting position of the sealing member 30. The tank holder unit 20 is provided with two positioning portions 20b, and each positioning portion 20b is provided at one end portion of the tank holder unit 20 in the Y direction and at both end portions in the X direction. When the discharge unit 3 and the tank holder unit 20 are joined with each other, the positioning portions 11a and the positioning portions 20b abut against each other in the Y direction to position the discharge unit 3 and the tank holder unit 20 in the Y direction.

The tank holder unit 20 is provided with four positioning pins 20c. Two positioning pins 20c are arranged aligned in the X direction relative to the flow path array arranged at one end in the X direction among the flow path arrays of the second flow paths 24. One of the positioning pins 20c is arranged at one end portion of the contact surface 20a in the Y direction and the other is arranged at the other end portion of the contact surface 20a in the Y direction. The other two positioning pins 20c are arranged aligned in the X direction relative to the flow path array arranged at a second position from the other end in the X direction among the flow path arrays of the second flow paths 24. One of the positioning pins 20c is arranged at one end portion of the contact surface 20a in the Y direction and the other is arranged at the other end portion of the contact surface 20a in the Y direction.

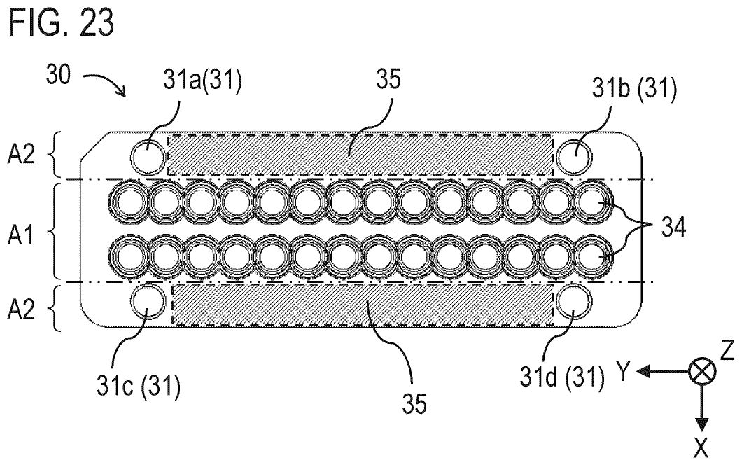

FIG. 23 is a plan view of the sealing member 30 and shows a contact surface with the discharge unit 3. A plurality of third flow paths 34 that communicate with the first flow paths 14 and the second flow paths 24 are formed in the sealing member 30. Each third flow path 34 penetrates the sealing member 30 from the contact surface with the tank holder unit 20 to the contact surface with the discharge unit 3, with one end communicating with the first flow path 14 and the other end communicating with the second flow path 24. The plurality of third flow paths 34 are arranged aligned in an array in the Y direction and constitute a flow path array. Two flow path arrays are formed aligned in the X direction with respect to one sealing member 30. The total number of third flow paths 34 in the two sealing members 30 is equal to the number of first flow paths 14 in the discharge unit 3 and the number of second flow paths 24 in the tank holder unit 20.

Each sealing member 30 has a rectangular shape, with three corners among the four corners formed as arcs and one corner formed as a notch, when viewed in a direction perpendicular to the contact surface with the discharge unit 3. Positioning holes 31 to engage with the tank holder unit 20 for positioning relative to the tank holder unit 20 are formed at the four corners of the sealing member 30. The positioning holes 31 are through-holes that penetrate the sealing member 30 from the contact surface with the tank holder unit 20 to the contact surface with the discharge unit 3 and are arranged on both sides of the flow path array of the plurality of third flow paths 34 in the X direction. A shape when viewed from the contact surface of the sealing member 30 with the discharge unit 3 and a shape when viewed from the contact surface of the sealing member 30 with the tank holder unit 20 are the same. The positioning holes 31 may be configured to be capable of engaging with not only the tank holder unit 20 but also with the discharge unit 3.

In the following description, the four positioning holes 31 will be distinguished and described as positioning holes 31a, 31b, 31c, and 31d as necessary. In the first embodiment, the positioning hole 31a and the positioning hole 31b are arranged aligned in the Y direction and the positioning hole 31c and the positioning hole 31d are arranged aligned in the Y direction. In addition, the positioning hole 31a and the positioning hole 31c are arranged aligned in the X direction and the positioning hole 31b and the positioning hole 31d are arranged aligned in the X direction. In other words, the positioning hole 31a and the positioning hole 31b are arranged in one end portion in the X direction and the positioning hole 31c and the positioning hole 31d are arranged in the other end portion in the X direction. In addition, the positioning hole 31a and the positioning hole 31c are arranged in one end portion in the Y direction and the positioning hole 31b and the positioning hole 31d are arranged in the other end portion in the Y direction.

When the sealing member 30 is divided by two imaginary lines parallel to the Y direction, a central region will be described as a first region A1 and regions adjacent to both sides of the first region A1 will be described second regions A2. The first region A1 is a region at the center in the X direction and is provided with a plurality of flow path arrays, each constituted of a plurality of third flow paths 34. The second regions A2 are regions on outer sides in the X direction and are regions adjacent to both sides of the first region A1 and provided with the positioning holes 31a to 31d.

In the second regions A2, a region between the positioning hole 31a and the positioning hole 31b and a region between the positioning hole 31c and the positioning hole 31d are planar margin portions 35 (margin regions) not provided with holes, respectively. The margin portions 35 are shown by hatching in FIG. 23.

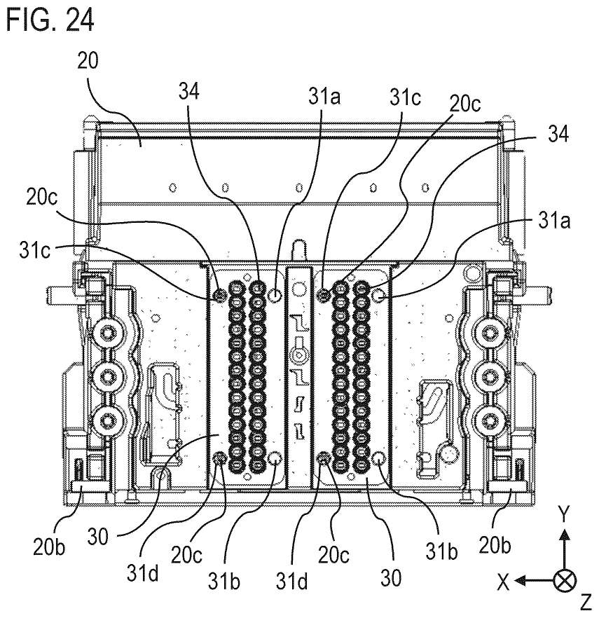

FIG. 24 is a plan view showing how two sealing members 30 are mounted on the tank holder unit 20. The sealing members 30 are mounted on the tank holder unit 20 in a state where the positioning pins 20c of the tank holder unit 20 engage with the positioning hole 31c and the positioning hole 31d of the sealing members 30. The engagement of the positioning holes 31 with the positioning pin 20c enables the sealing member 30 to be positioned relative to the tank holder unit 20 so that the second flow paths 24 and the third flow paths 34 are communicated with each other.

An assembly procedure of the liquid discharge head 1 will be described as a manufacturing method of the liquid discharge head 1 according to the first embodiment. The manufacturing method of the liquid discharge head 1 includes a mounting step of the sealing members 30 and a coupling step of the discharge unit 3 and the tank holder unit 20. First, the mounting step of the sealing members 30 will be described.

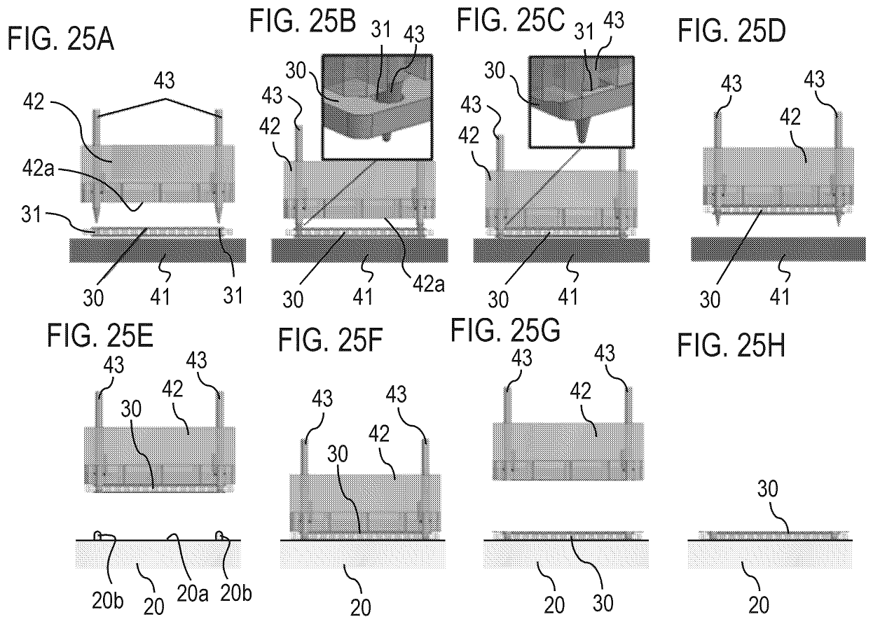

FIGS. 25A to 25H are explanatory diagrams of a mounting step of the sealing members 30. In FIGS. 25A to 25H, to clearly show a positional relationship among the respective members, positioning portions, and the like, some members such as the sealing members 30 are shown as being semi-transparent while other members are shown in varied degree of transparency.

The mounting of each sealing member 30 is performed by an automatic assembly apparatus that includes a supply stage 41 and a suction head 42 having a positioning pin 43. The supply stage 41 is a stage on which the sealing member 30 prior to mounting is set (placed). The suction head 42 is a suction unit configured to enable the sealing member 30 to be suctioned to a contact surface 42a of the suction head 42 by generating negative pressure. The positioning pin 43 is configured to be movable to a position where the positioning pin 43 protrudes from the contact surface 42a of the suction head 42 and a position where the positioning pin 43 retracts and withdraws from the contact surface 42a. The contact surface 42a has a rectangular shape and the positioning pin 43 is arranged in through-holes that open at four corners of the contact surface 42a.

FIG. 25A is a diagram showing a setting operation of the sealing member 30. In the mounting step of the sealing member 30, first, the sealing member 30 is set on the supply stage 41 of the automatic assembly apparatus.

FIG. 25B is a diagram showing a positioning operation of the sealing member 30 relative to the suction head 42. The suction head 42 is moved to above the supply stage 41 so that the positioning pins 43 arranged at the four corners of the suction head 42 are aligned with the positioning holes 31 arranged at the four corners of the sealing member 30. Then, the suction head 42 is slowly lowered so that the positioning pins 43 at the four corners of the suction head 42 are inserted into the positioning holes 31 at the four corners of the sealing member 30.

A leading end of the positioning pins 43 is formed in a tapered shape. Therefore, even if the relative position of the sealing member 30 with respect to the suction head 42 deviates slightly from an ideal position, the positioning pins 43 can be readily inserted into the positioning holes 31. As long as the positioning pins 43 are inserted into the positioning holes 31, the sealing member 30 is pushed by the positioning pins 43 and the position of the sealing member 30 is adjusted as the suction head 42 continues to descend. When the suction head 42 descends and the contact surface 42a comes into contact with the sealing member 30, the positioning holes 31 of the sealing member 30 are aligned with the centers of the positioning pins 43 and the sealing member 30 is accurately positioned on the suction head 42.

FIG. 25C is a diagram showing a grasping operation of the sealing member 30 by the suction head 42. The suction head 42 generates negative pressure in a state where the contact surface 42a is in contact with the sealing member 30. As a result, the sealing member 30 adheres to the contact surface 42a of the suction head 42 and the suction head 42 grasps the sealing member 30. In the first embodiment, since the margin portions 35 are formed in the second regions A2 of the sealing member 30, a sufficient contact area can be secured. Therefore, the sealing member 30 can be accurately suctioned and held by the suction head 42.

FIG. 25D is a diagram showing a lifting operation of the sealing member 30. The suction head 42 rises in a state where the sealing member 30 is sucked by vacuum suction. Due to this operation, the sealing member 30 integrally moves with the suction head 42 and is lifted from the supply stage 41.

FIG. 25E is a diagram showing a positioning operation of the sealing member 30 relative to the tank holder unit 20. The suction head 42 moves from directly above the supply stage 41 to directly above the tank holder unit 20. The tank holder unit 20 is installed so that the contact surface 20a provided with the positioning pins 20c faces upward and the suction head 42 moves so that the sealing member 30 opposes the contact surface 20a. In addition, the suction head 42 moves so as to align the positioning holes 31 of the sealing member 30 with the positioning pins 20c of the tank holder unit 20.

FIG. 25F is a diagram showing a placing operation of the sealing member 30 relative to the tank holder unit 20. After positioning, the suction head 42 descends and places the sealing member 30 being grasped by the suction head 42 on the contact surface 20a of the tank holder unit 20. As the suction head 42 descends, the positioning pins 20c of the tank holder unit 20 are inserted into the positioning holes 31 of the sealing member 30. The engagement of the positioning holes 31 with the positioning pins 20c enables the sealing member 30 to be mounted with high accuracy relative to the tank holder unit 20. The positioning pins 43 are retracted so as to be positioned above the contact surface 42a prior to the placing operation. Therefore, the positioning pins 43 do not come into contact with the tank holder unit 20.

FIG. 25G is a diagram showing a separating operation of the suction head 42. After placing the sealing member 30, the suction head 42 stops generation of negative pressure to release vacuum suction head, and breaks vacuum (approaches atmospheric pressure from a vacuum state). Subsequently, the suction head 42 rises and separates from the sealing member 30.

FIG. 25H is a diagram showing a state after mounting of the sealing member 30 is completed. Through the sequence of operations described above, the sealing member 30 is mounted to the tank holder unit 20.

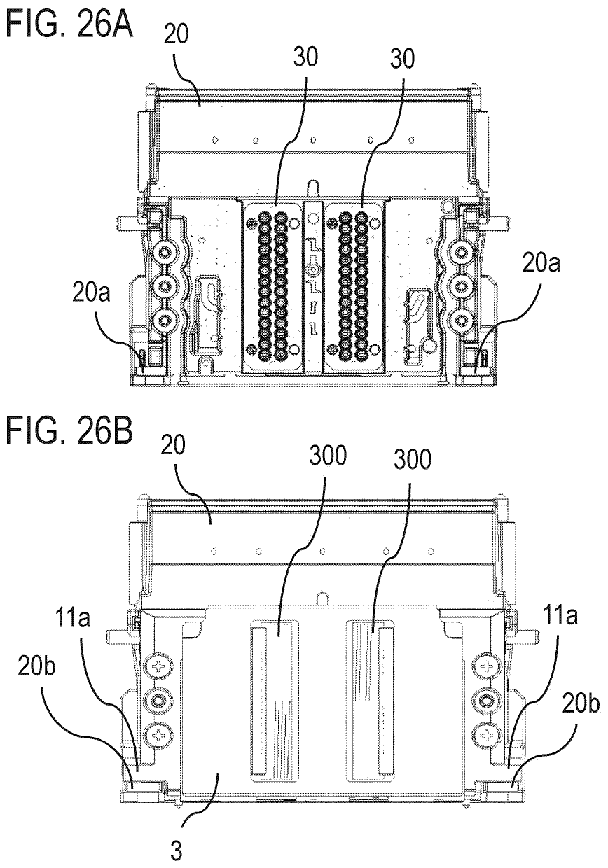

After the mounting step of the sealing members 30, the coupling step of the discharge unit 3 and the tank holder unit 20 is performed. FIGS. 26A and 26B are explanatory diagrams of the coupling step of the discharge unit 3 and the tank holder unit 20.

FIG. 26A is a plan view of the tank holder unit 20 after completion of the mounting step of the sealing member 30. In the coupling step, the discharge unit 3 is coupled to the tank holder unit 20 mounted with the sealing member 30. To adjust the relative positions of the discharge unit 3 and the tank holder unit 20, the positioning portion 11a of the supporting plate 11 is brought into contact with the positioning portion 20b of the tank holder unit 20. Then, the discharge unit 3 is coupled to the tank holder unit 20 by screws. FIG. 26B is a plan view of the tank holder unit 20 after coupling of the discharge unit 3. After completing the above steps, the liquid discharge head 1 is assembled.

The sealing member 30 will now be described in greater detail. As in the configuration of the first embodiment, arranging a large number of the third flow paths 34 in a row enables the margin portions 35 that are elongated in the longitudinal direction of the sealing member 30 to be provided in the sealing member 30 as regions for adhesive grasping. In particular, when the sealing member 30 is an elastic member, the sealing member 30 becomes susceptible to deformation when elongated. As a result, depending on where the positioning holes 31 are arranged, there is a risk that the suction head 42 may be unable to generate negative pressure and thus unable to grasp the sealing member 30 due to deformation of the sealing member 30 during suction grasping. In consideration thereof, one or more positioning holes 31 are arranged in end portions in the longitudinal direction (vicinity of outermost periphery) so that the sealing member 30 can be grasped by suction in a flat state.

In the first embodiment, when viewed in a direction perpendicular to a plane on which the positioning holes 31 open, dimensions of the sealing member 30 are 39.12 mm in the longitudinal direction of the rectangle (Y direction) and 13.58 mm in the transverse direction (X direction). In other words, the sealing member 30 has a rectangular shape that is elongated in the Y direction and has an aspect ratio of 3:1. In addition, the third flow paths 34 have a diameter of 1.77 mm. As shown in FIG. 23, the sealing member 30 is provided with two flow path arrays, each array constituted of 14 third flow paths 34. In other words, a total of 28 third flow paths 34 are provided in one sealing member 30. For the purposes of stable liquid supply and liquid circulation, each of the flow path arrays include seven or more third flow paths 34.

In the first embodiment, the third flow paths 34 are provided so as to correspond to inks of four colors. More specifically, three third flow paths 34 for supply (in) and four third flow paths 34 for recovery (out) are provided for each color.

An arrangement order of the third flow paths 34 corresponding to each color: black (K), cyan (C), magenta (M), and yellow (Y), will be described in greater detail. In the following description, a role of each third flow path 34 will be indicated using a single letter symbol (K, C, M, or Y) representing the ink color and symbols “in” and “out” indicating whether the flow path is for supply or recovery. In FIG. 24, in the left-side flow path array of the sealing member 30 arranged on the left side, a sequence of the third flow paths 34 in an order of Y-out, M-out, Y-in, and M-in from top to bottom are repeated three times, followed by Y-out and M-out below the sequences. In addition, in the right-side flow path array of the sealing member 30 arranged on the left side, a sequence of the third flow paths 34 in an order of C-out, K-out, C-in, and K-in from top to bottom are repeated three times, followed by C-out and K-out below the sequences. In addition, in the left-side flow path array of the sealing member 30 arranged on the right side, a sequence of the third flow paths 34 in an order of K-out, C-out, K-in, and C-in from top to bottom are repeated three times, followed by K-out and C-out below the sequences. In addition, in the right-side flow path array of the sealing member 30 arranged on the right side, a sequence of the third flow paths 34 in an order of M-out, Y-out, M-in, and Y-in from top to bottom are repeated three times, followed by M-out and Y-out below the sequences. In this manner, in the first embodiment, one flow path array corresponds to two ink colors.

The positioning holes 31 are through-holes of which a cross-sectional shape is a circle with a diameter of 2.1 mm. The four positioning holes 31 are arranged at four corners of the sealing member 30 with a longitudinal pitch of 29.64 mm and a transverse pitch of 9.98 mm. From the perspective of ease of positioning, the positioning holes 31 have a cross-sectional shape with a diameter of 2.0 mm or more.

The margin portions 35 arranged on both sides of the flow path array are provided on the sealing member 30 as rectangular regions each having a longitudinal length of 27.16 mm and a transverse length of 3.56 mm. In addition, on the surface on which the positioning holes 31 of the sealing member 30 open, a total area of the sealing member 30 is 526.67 mm², and a total area of the margin portions 35 is 193.65 mm². Therefore, a ratio of the total area of the margin portions 35 to the total area of the sealing member 30 is approximately 37%. In addition, a total area of a portion of the second region A2 excluding the positioning holes 31 is 193.65 mm² or more, and a ratio of the total area to the total area of the sealing member 30 is 37% or more. To securely and accurately grasp the sealing member 30 with the suction head 42, the ratio of the total area of the margin portions 35 to the total area of the sealing member 30 is suitably 37% or more.

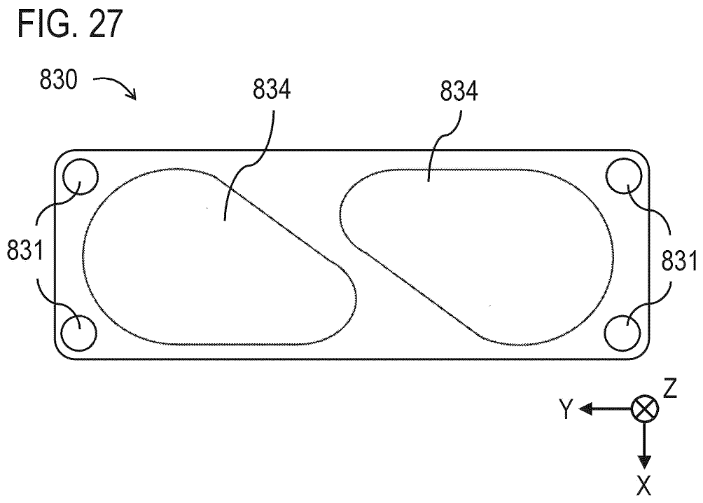

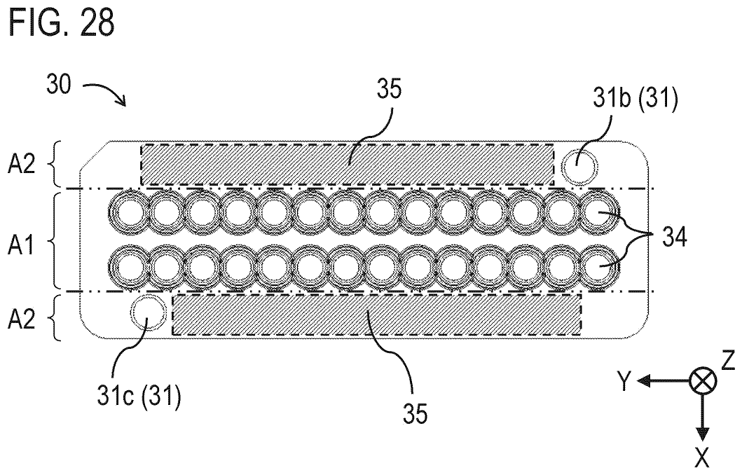

Next, a sealing member 830 according to a comparative embodiment will be described. FIG. 27 is a plan view of the sealing member 830 according to the comparative embodiment and shows a contact surface with the discharge unit 3. In the sealing member 830, a flow path 834 with a large opening area and an opening shape that is approximately fan-shaped is provided at two locations. The flow paths 834 are formed so as to extend from one end portion to another end portion in the X direction. In addition, welding pin insertion holes 831 are formed at the four corners of the sealing member 830 to weld and couple a discharge-side case and a supply-side case together via the sealing member 830. Therefore, in the comparative embodiment, the margin portions for sucking and grasping the sealing member 830 cannot be sufficiently secured. Due to the large opening shape of the flow paths 834, it is difficult to provide a large number of the flow paths 834 in the sealing member 830. Therefore, configurations such as the comparative embodiment are not suitable as the shape of a sealing member for providing and fixing a large number of (three or more) flow paths to the discharge-side case and the supply-side case.

On the other hand, in the first embodiment, a large number of the third flow paths 34 are arranged in rows and the margin portions 35 and the positioning holes 31 are provided on both sides of the rows. Therefore, many flow paths can be communicated while providing margin portions 35 with sufficient areas. In addition, the sealing member 30 can be grasped by the suction head 42 with high accuracy and the sealing member 30 can be mounted with high accuracy relative to the tank holder unit 20. Consequently, liquid leakage of the liquid discharge head 1 can be more reliably prevented.

### Second Embodiment

Next, a second embodiment according to the present disclosure will be described. The second embodiment differs from the first embodiment in the configuration of the sealing member 30. Hereafter, only points of the configuration of the second embodiment that differ from the configuration of the first embodiment will be described. Among the components of the second embodiment, components similar to those of the first embodiment will be denoted by the same reference signs and descriptions thereof are not repeated, for clarity, while being incorporated by reference.

FIG. 28 is a plan view of the sealing member 30 according to the second embodiment and shows a contact surface with the discharge unit 3. The sealing member 30 according to the second embodiment has the same outer peripheral shape and the configuration of the third flow paths 34 as the first embodiment but differs from the first embodiment in the number of the positioning holes 31.

The sealing member 30 is provided with two positioning holes 31. Since arrangement positions thereof are the same as those of the positioning holes 31b and 31c according to the first embodiment, similar reference signs will be used to distinguish and explain the positioning holes 31 as necessary. When viewed in a perpendicular direction to the contact surface with the discharge unit 3, the positioning holes 31b and 31c are each positioned on a diagonal of the contact surface. In other words, the positioning hole 31b is arranged in one end portion in the X direction and the Y direction and the positioning hole 31c is arranged in the other end portion in the X direction and the Y direction.

In addition, the margin portions 35 for sucking and grasping the sealing member 30 are provided in the second regions A2 of the sealing member 30. A total area of the margin portions 35 according to the second embodiment can be made larger than in the first embodiment since there are fewer positioning holes 31.

Even with the configuration of the second embodiment, a large number of the third flow paths 34 can be arranged in rows and the margin portions 35 and the positioning holes 31 can be provided on both sides of the rows. Therefore, many flow paths can be communicated while providing margin portions 35 with sufficient areas. In addition, the sealing member 30 can be grasped by the suction head 42 with high accuracy while suppressing deformation of the sealing member 30 and maintaining a flat state of the sealing member 30, and the sealing member 30 can be mounted with high accuracy relative to the tank holder unit 20. Consequently, liquid leakage of the liquid discharge head 1 can be more reliably prevented.

### Third Embodiment

Next, a third embodiment according to the present disclosure will be described. The third embodiment differs from the first embodiment in the configuration of the sealing member 30. Hereafter, only points of the configuration of the third embodiment that differ from the configuration of the first embodiment will be described. Among the components of the third embodiment, components similar to those of the first embodiment will be denoted by the same reference signs and descriptions thereof are not repeated, for clarity, while being incorporated by reference.

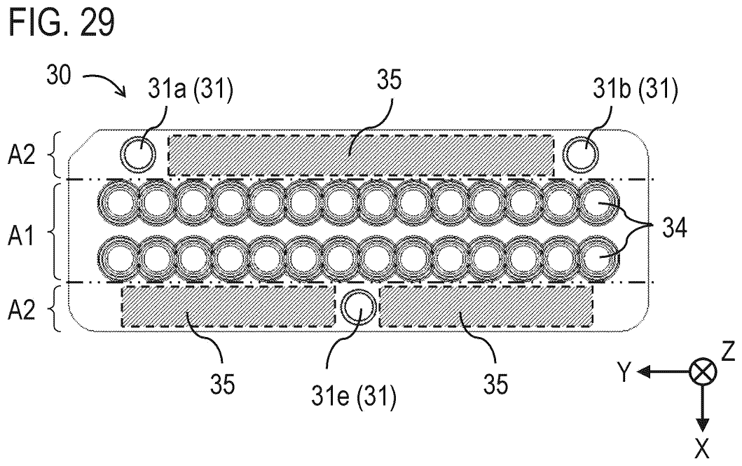

FIG. 29 is a plan view of the sealing member 30 according to the third embodiment and shows a contact surface with the discharge unit 3. The sealing member 30 according to the third embodiment has the same outer peripheral shape and the configuration of the third flow paths 34 as the first embodiment but differs from the first embodiment in the number and arrangement positions of the positioning holes 31.

The sealing member 30 is provided with three positioning holes 31. Since arrangement positions of two of the positioning holes 31 are the same as those of the positioning holes 31a and 31b according to the first embodiment, similar reference signs will be used to distinguish and explain the positioning holes 31 as necessary. In addition, the one remaining positioning hole 31 will be referred to as a positioning hole 31e.

In the third embodiment, the positioning hole 31a (first positioning hole) is arranged in one end portion in the Y direction and one end portion in the X direction, and the positioning hole 31b (second positioning hole) is arranged in the other end portion in the Y direction and the other end portion in the X direction. In addition, the positioning hole 31e (third positioning hole) is arranged in a center portion in the Y direction and the other end portion in the X direction. In other words, when viewed in a perpendicular direction to the contact surface with the discharge unit 3, connecting the axial centers of the respective positioning holes 31 with imaginary lines forms an isosceles triangle.

In addition, the margin portions 35 for sucking and grasping the sealing member 30 are provided in the second regions A2 of the sealing member 30. A total area of the margin portions 35 according to the third embodiment can be made larger than in the first embodiment since there are fewer positioning holes 31.

As described above, even in the third embodiment, a large number of the third flow paths 34 can be arranged in rows and the margin portions 35 and the positioning holes 31 can be provided on both sides of the rows. Therefore, many flow paths can be communicated while providing margin portions 35 with sufficient areas. In addition, the sealing member 30 can be grasped by the suction head 42 with high accuracy while suppressing deformation of the sealing member 30 and maintaining a flat state of the sealing member 30, and the sealing member 30 can be mounted with high accuracy relative to the tank holder unit 20. Consequently, liquid leakage of the liquid discharge head 1 can be more reliably prevented.

According to the present disclosure, the ability of a liquid discharge head to prevent ingress of liquids is improved.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-015970, filed Feb. 3, 2025, which is hereby incorporated by reference herein in its entirety.

What is claimed is:

1. A liquid discharge head, comprising:
a discharge unit configured to discharge liquid, the discharge unit including a plurality of first liquid flow paths;
a supply unit fixed to the discharge unit and configured to supply the liquid to the discharge unit, the supply unit including a plurality of second liquid flow paths; and
a sealing member sandwiched by the discharge unit and the supply unit, the sealing member including a plurality of third flow paths in communication with the plurality of first liquid flow paths and the plurality of second liquid flow paths,
wherein the sealing member includes a plurality of flow path arrays, each flow path array including the plurality of third flow paths arranged in a predetermined column direction,
wherein the sealing member includes a plurality of positioning holes configured to engage with the supply unit, and
wherein the plurality of positioning holes are arranged on both sides of the flow path arrays in a direction intersecting with a column direction.

2. The liquid discharge head according to claim 1,
wherein the plurality of positioning holes include a rectangular shape opening on a surface of the sealing member.

3. The liquid discharge head according to claim 2,
wherein at least one positioning hole of the plurality of positioning holes is arranged at a respective corner of the rectangular shaped surface.

4. The liquid discharge head according to claim 2,
wherein at least two positioning holes of the plurality of positioning holes are arranged on diagonals of the rectangular shaped surface.

5. The liquid discharge head according to claim 1, wherein:
a first positioning hole of the plurality of positioning holes is arranged in one end portion in the column direction of the sealing member and in one end portion in the intersecting direction;
a second positioning hole of the plurality of positioning holes is arranged in another end portion in the column direction of the sealing member and in the one end portion in the intersecting direction; and
a third positioning hole of the plurality of positioning holes is arranged in a center portion in the column direction of the sealing member and in another end portion in the intersecting direction.

6. The liquid discharge head according to claim 1,
wherein the sealing member is a rectangular shape elongated in the column direction, viewed in a direction perpendicular to a surface on which the plurality of positioning holes are provided.

7. The liquid discharge head according to claim 1,
wherein the each flow path array includes seven or more third flow paths.

8. The liquid discharge head according to claim 1,
wherein the positioning holes are configured as circular through-holes with a diameter of 2.0 mm or more.

9. The liquid discharge head according to claim 8,
wherein, in a case the sealing member is divided by two lines parallel to the column direction, with a first region provided on a center side and second regions provided adjacent to respective sides of the first region, on a surface of the sealing member on which the plurality of positioning holes open, a ratio of a total area of a portion of the second regions, excluding the positioning holes, to a total area of the surface of the sealing member is 37% or more.

10. The liquid discharge head according to claim 1,
wherein the supply unit includes a circulation unit and a holder to which the circulation unit is mounted, and
wherein the liquid circulates between the discharge unit and the circulation unit.

11. The liquid discharge head according to claim 1,
wherein the supply unit includes a holder and a plurality of the circulation units mounted to the holder.

12. A liquid discharge apparatus, comprising:
a conveying roller configured to convey a recording medium; and
a liquid discharge head according to claim 1,
wherein the liquid discharge head is configured to discharge liquid onto the recording medium conveyed by the conveying roller.

13. A method of manufacturing a liquid discharge head, the liquid discharge head including a discharge unit including a plurality of first liquid flow paths; a supply unit fixed to the discharge unit, including a plurality of second liquid flow paths, and configured to supply liquid to the discharge unit; and a sealing member sandwiched by the discharge unit and the supply unit, the sealing member including a plurality of third flow paths in communication with the plurality of first liquid flow paths and the plurality of second flow liquid paths, and a plurality of flow path arrays, each flow path array including the plurality of third flow paths arranged in a column direction, the manufacturing method comprising:
a grasping operation including sucking a surface on which the plurality of third flow paths of the sealing member open with a suction head and grasping the sealing member;
a positioning operation including positioning the sealing member grasped by the suction head relative to the supply unit, so that a contact surface of the supply unit contacts the sealing member; and
a mounting operation of moving the suction head and placing the sealing member on the supply unit.

14. The method according to claim 13,
wherein the sealing member includes a plurality of positioning holes configured to engage with the supply unit.

15. The method according to claim 14, wherein the plurality of positioning holes are arranged on both sides of the flow path arrays in a direction intersecting with a column direction.

16. The method according to claim 14,
wherein, in a case the sealing member is divided by two lines parallel to the column direction, a first region is provided on a center side and second regions are provided adjacent to respective sides of the first region.

17. The method according to claim 15,
wherein, on a surface of the sealing member on which the plurality of positioning holes open, a ratio of a total area of a portion of the second regions, excluding the positioning holes, to a total area of the surface of the sealing member is 37% or more.

18. The method according to claim 15, wherein a plurality of positioning pins protrude from the contact surface, and in the grasping operation, the suction head grasps the sealing member so that the contact surface comes into contact with the second regions of the sealing member, in a state where the positioning pins are inserted into the positioning holes.

19. The method according to claim 14,
wherein the supply unit has a plurality of positioning portions to engage with the positioning holes, and, in the positioning operation, the sealing member is positioned so that the positioning holes are aligned with respective positioning portions.
